(19) United States
(12) Patent Application Publication
(10) Pub. No.: US 2024/0181430 A1
(43) Pub. Date: Jun. 6, 2024

(54) POROUS SORPTIVE SOLID PHASE MICROEXTRACTION DEVICES AND PREPARATION THEREOF

(71) Applicant: MEMORIAL UNIVERSITY OF NEWFOUNDLAND, St. John's (CA)

(72) Inventors: Aliasghar GOLBABANEZHADAZIZI, Edmonton (CA); Fereshteh SHAHHOSEINI, Edmonton (CA); Christina BOTTARO, St. John’s (CA); Evan LANGILLE, Mount Pearl (CA)

(21) Appl. No.: 18/548,618

(22) PCT Filed: Mar. 4, 2022
(86) PCT No.: PCT/CA2022/050316

§ 371 Date: Sep. 1, 2023

Related U.S. Application Data
(60) Provisional application No. 63/200,396, filed on Mar. 4, 2021.

(51) Int. Cl. B01J 20/28; B01J 20/32

(52) U.S. Cl. CPC B01J 20/28033; B01J 20/3204; B01J 20/3212; B01J 20/3282; B01J 2220/46

(57) ABSTRACT

The present application relates to processes of preparing a plurality of porous sorptive solid phase microextraction (SPME) devices and also to the porous sorptive SPME devices prepared therefrom, including porous sorptive SPME metallic and fiberglass mesh supported devices. The present application also relates a method of using the porous sorptive SPME devices to extract one or more analytes from a sample matrix such as a bodily fluid or a water sample.

### RELATED APPLICATIONS

The present application claims the benefit of priority from U.S. provisional patent application Ser. No. 63/200,396 filed on Mar. 4, 2021, the contents of which are incorporated herein by reference in their entirety.

### FIELD

The present application relates to processes of preparing porous sorptive solid phase microextraction (SPME) devices and to porous sorptive SPME devices prepared therefrom. The present application also relates to methods of using porous sorptive SPME devices to extract one or more analytes from a sample matrix, for example, bodily fluid or water samples.

### BACKGROUND

Sample preparation plays a crucial role in analytical chemistry to provide sensitive, accurate, precise, robust, and selective method for determination of compounds of interest. Treatment of samples allows for the isolation and preconcentration of the analytes while removing interfering compounds associated with the matrix [1]. Sample preparation steps before instrumental analysis usually relies on well-established techniques such as liquid-liquid extraction (LLE) [2] and solid phase extraction (SPE) [3]. LLE employs large volumes of usually toxic organic solvents in order to extract compounds of interest. It is laborious and time-consuming [4] with a high equipment and personnel demand. SPE is performed using packed sorbents to retain analytes and it is a more modern method that is well accepted by routine analytical labs. However, in this technique, enrichment of analytes from the sample matrix is performed in several, sometimes manual, steps which introducing errors to analytical methods [5]. Therefore, there has been a huge effort in the sample preparation field to introduce miniaturized techniques such as solid phase microextraction (SPME) [6], stir bar sorptive extraction (SBSE) [7], single drop microextraction (SDME) [8], hollow fiber liquid phase microextraction (HF-LPME) [9], dispersive liquid-liquid microextraction (DLLME) [10], cloud point extraction (CPE) [11], and dispersive solid phase extraction (DSPE) [12]. In most of these techniques, a small amount of extraction phase (solid or liquid phase) is utilized for efficient and fast extraction of analytes from a large or small sample.

SPME has attracted the most attention among miniaturized techniques in recent years due to its potential for portability, on-site, in-vivo sampling, automation, and online detection systems [13]. This technique is based on partitioning of analytes between the sample and an extraction phase coated on a substrate such as a fiber using headspace or direct immersion exposure [14]. SPME has been successfully deployed for analysis of environmental [15], biological [16] and food [17] samples. Though there are several disadvantages associated with this technique such as low extraction efficiency and selectivity, fragility of fibers [18], fouling in complex matrices [19] and high cost of commercially available SPME fibers. Thin film microextraction (TFME) is one of the most recent formats of SPME and employs thin film of the extraction phase coated on a substrate. Due to the increased ratio of sorbent surface area per sample volume, the extracted mass of analytes and analytical sensitivity can be improved. Furthermore, the higher extraction rate of analytes in TFME reduces the sample preparation time [20]. TFME has also witnessed a lot of attention because of the potential for direct analysis via thermal desorption using gas chromatography (GC) [21] or direct coupling to mass spectrometry (MS) [22]. The robustness of TFME devices allow for on-site extraction and analysis [23]. TFME allows analysis of biological [24, 25] and environmental samples [23, 26, 27] through more environmentally friendly and high-throughput protocols.

There are a few commercially available thin-film devices that rely on a small scale home-made manual preparation [24, 28]. In such procedures, the sorptive particles are dispersed in the binder, then the mixture is applied onto the substrate by dipping or brushing. After curing the binder, several post-curing steps are required on these semi-permeable polymers to remove unreacted materials which could bleed and interfere during the analysis. Poor repeatability between individual devices and long preparation time are the main drawbacks of currently available technologies to fabricate such devices for extraction proposes. Single-use, porous thin films which can be used for the extraction of analytes have been prepared [29, 30]. However, the fabrication technique relies on manual manipulation which can be a source of error and lead to low precision in the analytical method.

Apart from the fabrication techniques, the chemistry of the coating can be changed by altering the composition and implementation of other materials such as sol-gel [31], ion liquids [32], metal-organic frameworks (MOFs) [33] and molecularly imprinted polymers (MIPs) [34] in extraction devices. MIPs are selective materials that are prepared by polymerization of a monomer and a crosslinker in presence of a template molecule. The template molecule has interactions with prepolymer components such as monomer, and results in template-monomer complexes. After polymerization, template molecules are removed resulting in cavities selective towards recognition of analytes [35]. The MIP technology has witnessed a huge progress in the field of separation and adsorption particularly MIP based SPE cartridges. However, there is no commercially available extraction device in the market such as MIP-SPME or MIP-SBSE.

### SUMMARY

The Applicant has developed a scalable and high throughput fabrication process of preparing a plurality of sorptive solid phase microextraction (SPME) devices which can be used for the analysis of targeted and untargeted molecules and/or analytes in liquid, solid and gaseous samples.

Accordingly, the present application includes a process of preparing a plurality of porous sorptive solid phase microextraction (SPME) devices optionally comprising, consisting of, or consisting essentially of:

depositing a prepolymer composition on a surface of a solid support sheet to form a uniform prepolymer composition layer on the solid support sheet;

curing the prepolymer composition layer to form a porous sorptive polymer coated sheet; and

cutting the porous sorptive polymer coated sheet to form the plurality of porous sorptive SPME devices.

In an embodiment, the present application optionally includes depositing a prepolymer composition on an entire surface of a solid support sheet to form a uniform prepolymer composition layer on the solid support sheet. In an embodiment, the present application optionally includes depositing a prepolymer composition on substantially an entire surface of a solid support sheet to form a substantially uniform prepolymer composition layer on the substantially the entire surface of the solid support sheet.

The present application also includes a porous sorptive SPME device (optionally a plurality of porous sorptive SPME devices) produced by the process described above.

The present application further includes a method of extracting one or more analytes from a sample matrix optionally comprising, consisting of, or consisting essentially of
providing a porous sorptive solid phase microextraction (SPME) device as described above comprising a porous sorptive polymer coating layer covering at least a portion of a solid support;
exposing the porous sorptive polymer coating layer to the sample matrix comprising the one or more analytes under conditions for the porous sorptive polymer coating layer to extract the one or more analytes from the sample matrix; and
separating the porous sorptive SPME device from the sample matrix.

In an embodiment, the methods and/or porous sorptive SPME device (optionally a plurality of porous sorptive SPME devices) of the present disclosure optionally comprise, consist of, or consist essentially of the embodiments described herein.

Other features and advantages of the present application will become apparent from the following detailed description. It should be understood, however, that the detailed description and the specific examples, while indicating embodiments of the application, are given by way of illustration only and the scope of the claims should not be limited by these embodiments, but should be given the broadest interpretation consistent with the description as a whole

### BRIEF DESCRIPTION OF DRAWINGS

The embodiments of the application will now be described in greater detail with reference to the attached drawings in which:

FIG. 1 shows an exemplary experimental set-up for high-throughput fabrication of exemplary SPME devices of the application.

FIG. 2 shows schematics of exemplary SPME devices of the application.

FIG. 3 shows an exemplary workflow for extraction using exemplary thin film/coated mesh SPME device and the analysis of organophosphorus pesticides (OPPs) in water samples.

FIG. 4 shows an exemplary workflow for spot sampling with an exemplary SPME device and direct analysis using mass spectrometry (MS).

FIG. 5 shows scanning electron micrographs of a) an exemplary thin film SPME device prepared using drop cast technique; b) exemplary porous polymeric thin film SPME device prepared using spray technique; c) and d) fiber glass sheets; e) and f) exemplary fiber glass sheets coated with porous polymer sorbent; g) and h) exemplary fiber glass sheets coated with molecularly imprinted polymer (MIP) sorbent, i) cross section of exemplary polymer coated stainless steel SPME device (blade) cut using waterjet cutting and prepared from prepolymer composition of Formula Il showing the thickness of the polymer coating layer to be 41.16 μm, 39.95 μm and 41.04 μm at the measured positions, and j) and k) cross section of exemplary polymer coated fiberglass mesh SPME devices prepared with prepolymer composition of Formula III showing diameters of measured fiberglass fibers of 8.794 μm, 8.618 μm and 10.54 μm.

FIG. 6 shows scanning electron micrographs of a) a comparative thin film SPME device prepared by spraying pre-cut metallic blades and b) an exemplary thin film SPME device prepared by spraying metallic sheets followed by waterjet cutting.

FIG. 7 shows the inter-mesh SPME device variability for extraction of OPPs (n=15).

FIG. 8 are graphs showing the effect of parameters of desorption efficiency of OPPs from exemplary tip coated blade SPME device. a) type of desorption solvent (500 μL agitated at 1000 rpm for 30 min); b) desorption agitation (500 μL acetonitrile agitated for 30 min); and c) desorption time (500 μL acetonitrile agitated at 1500 rpm). Sample: 40 mL sample solution of OPPs at 5 ng mL⁻¹; Extraction at 1000 rpm for 30 min.

FIG. 9 are graphs showing the extraction time profile using a) exemplary tip-coated blade extraction device (5 mm length) for extraction from 40 ml sample solution, b) exemplary coated blade SPME device (20 mm length) for extraction from 20 ml sample solution.

FIG. 10 are graphs showing a) the effect of fabrication procedure (spraying and drop-casting) on the extraction efficiency of OPPs using thin film MIPs . Extraction was performed for 60 min from 20 ml sample solutions of OPPs (50 μg L⁻¹) (n=3); and b) the effect of length of polymer coating on exemplary blade SPME devices coated with sorptive materials on the extraction efficiency of OPPs. Extraction was performed for 60 min from 20 mL sample solutions of OPPs (50 μg L⁻¹).

FIG. 11 are graphs showing the extraction time profile for selected OPPs using fiberglass mesh SPME devices-coated sorptive polymer (a and b).

FIG. 12 shows the effect of extraction time on the efficiency of adsorption of OPPs using MIP- and non-molecularly imprinted (NIP)-coated fiberglass mesh SPME devices.

FIG. 13 shows the calibration of cocaine via direct coupling of exemplary sorptive phase coated SPME blades to the Xevo TQ-S tandem mass spectrometer MS/MS. The standard solutions were prepared in methanol/water (9:1, v/v) containing 0.1% FA.

FIG. 14 shows the total ion chromatograms of drugs obtained from the ionization of exemplary sorptive phase coated SPME blades from blank and spiked urine samples.

FIG. 15 is a graph showing the absolute recovery values of drugs from a urine sample using spot sampling with an exemplary SPME device followed by direct MS measurement (n=3). Sample: 10 μL human urine spiked with 25 ng mL⁻¹ of multi mixture of drugs (cocaine, methamphetamine, MDMA, methadone); Static extraction for 1 min; Washing: 1 mL water; Desorption: 10 μL mixture methanol/water (9:1, v/v) containing 0.1% FA; Run time: 1 min.

FIG. 16 is a graph showing comparison of the relative signal intensity of extraction of drugs using spot sampling with exemplary SPME devices followed by direct MS measurement (n=12) (RSD=9%).

FIG. 17 is a graph showing the calibration from human urine for methadone, triangles represent accuracy and precision checkpoints (n=3).

FIG. 18 are graphs showing thermal desorption analysis of selected OPPs from water samples using exemplary fiberglass mesh SPME device.

### DETAILED DESCRIPTION

### I. Definitions

Unless otherwise indicated, the definitions and embodiments described in this and other sections are intended to be applicable to all embodiments and aspects of the present application herein described for which they are suitable as would be understood by a person skilled in the art.

The term “and/or” as used herein means that the listed items are present, or used, individually or in combination. In effect, this term means that “at least one of” or “one or more” of the listed items is used or present.

As used in the present application, the singular forms “a”, “an” and “the” include plural references unless the content clearly dictates otherwise. For example, an embodiment including “a negative response” should be understood to present certain aspects with one negative, or two or more additional negative responses.

In embodiments comprising an “additional” or “second” component, the second component as used herein is chemically different from the other components or first component. A “third” component is different from the other, first and second components, and further enumerated or “additional” components are similarly different.

The term “suitable” as used herein means that the selection of the particular molecule, material and/or conditions would depend on the specific synthetic manipulation to be performed, and the identity of the molecule(s) and/or material(s) to be transformed, but the selection would be well within the skill of a person trained in the art. All synthetic process/method steps described herein are to be conducted under conditions sufficient to provide the product shown. A person skilled in the art would understand that all reaction conditions, including, for example, reaction solvent, reaction time, reaction temperature, reaction pressure, reactant ratio and whether or not the reaction should be performed under an anhydrous or inert atmosphere, can be varied to optimize the yield of the desired product and it is within their skill to do so.

The term “about” as used herein means a reasonable amount of deviation of the modified term such that the end result is not significantly changed. These terms of degree should be construed as including a deviation of at least ±5% of the modified term if this deviation would not negate the meaning of the word it modifies or unless the context suggests otherwise to a person skilled in the art.

The term “porous polymer” as used herein, is intended to include a member of a class of porous crosslinked polymers penetrated by pores through which solutions can diffuse. Pores are regions between densely packed polymer chains.

The term “solid phase extraction” as used herein, is intended to include a process employing a solid phase for isolating compounds or classes of compounds or molecular species from fluid phases such as gases and liquids by, for example, sorption.

The term “sorptive” as used herein, of describes the ability of a material to take up and hold another material by absorption or adsorption.

The term “% v/v” means a percentage expressed in terms of volume of a component over the total volume of a formulation multiplied by 100.

The term “molecularly imprinted polymer” or “MIP” as used herein refers generally to a polymeric mold-like structure having one or more pre-organized recognition sites which complement the shape of at least a portion of a target or imprint molecule and which contain interactive moieties that complement the spacing of, and exhibit an affinity for, at least a portion of the binding sites on the target or imprint molecule.

The term “compatible” as used herein, for example as in a polymer coating is compatible with a solvent, a sample matrix and/or a desorption technique means that the polymer coating when exposed to the solvent, a sample matrix and/or a desorption technique does not, for example, swell, or loses less than about 5% of its weight and/or releases the one or more analytes efficiently during the desorption process.

### II. Solid Phase Microextraction (SPME) Devices and Processes of Preparing SPME Devices of the Application

The Applicant has developed a scalable and high throughput fabrication process of preparing a plurality of sorptive solid phase microextraction (SPME) devices which can be used for the analysis of targeted and untargeted molecules and/or analytes in liquid, solid or gaseous samples.

In an embodiment, the Applicant has developed a process of preparing a plurality of sorptive solid phase microextraction (SPME) devices wherein a prepolymer composition is deposited, for example, by spraying, on a solid support such as a metal, metal alloy, paper, wood, plastic, glass, fiber-reinforced plastic such as fiberglass, or fabric sheet. The prepolymer composition layer is then cured, for example, by photopolymerization, to form a porous sorptive polymer coating layer on the support sheet which can sorb and retain molecules and/or analytes of interest from various matrices. The formed porous sorptive polymer coated sheet can then be cut into one or more desirable formats to form the plurality of individual solid phase microextraction devices. Therefore, the Applicant has developed a high throughput process which provides a plurality of sorptive SPME devices which are robust, and compatible with different polymer compositions and various complex sample matrices and which do not suffer from a lack of inter- and intra-device variability compared to devices produced by other known methods. Additionally, the batch production process provides a plurality of sorptive SPME devices which are reliable and inexpensive and therefore the process is also cost effective.

The Applicant has also prepared sorptive solid phase microextraction (SPME) devices using the process described above. In particular, sorptive SPME devices have been prepared by cutting a polymer coated metallic support sheet to form a plurality of individual SPME devices, referred to as blades. Similarly, sorptive solid phase microextraction mesh devices have been prepared by cutting a polymer coated fiberglass mesh support sheet to form a plurality of coated mesh microextraction devices. The process of preparing the porous sorptive solid phase microextraction devices is compatible with different polymer compositions which can be chosen according to the desired selectivity and stability of the microextraction devices. Sorptive solid phase microextraction devices using both molecularly imprinted polymer (MIPs) for selective extraction and also non-imprinted polymers (NIPs) which can be used as sorbents for a wider range of analytes have been prepared.

The use of the prepared sorptive solid phase microextraction devices in the extraction and analysis of analytes from sample matrices, for example, organophosphorus pesticide (OPPs) from water samples and drugs of abuse from bodily fluids has been shown. Further, the Applicant has been shown that due to the high throughput batch preparation of the solid phase microextraction devices the extraction process can be carried out simultaneously using multiple porous sorptive polymer devices providing a semi-automated extraction process and/or system, and/or semi-automated extraction and detection processes and/or systems.

Accordingly, the present application includes a process of preparing a plurality of porous sorptive solid phase microextraction (SPME) devices comprising:

depositing a prepolymer composition on a surface of a solid support sheet to form a uniform prepolymer composition layer on the solid support sheet;

curing the prepolymer composition layer to form a porous sorptive polymer coated sheet; and

cutting the porous sorptive polymer coated sheet to form the plurality of porous sorptive SPME devices.

In an embodiment, the porous sorptive polymer coated sheet comprises a porous sorptive polymer coating layer on the solid support sheet. In an embodiment, the porous sorptive polymer coated sheet comprises a uniform porous sorptive polymer coating layer on the solid support sheet.

In an embodiment, the surface of the solid support sheet comprises a deposition surface (e.g., a surface to be coated). In an embodiment, the surface of the solid support sheet further comprises a non-deposition surface (e.g., surface of the solid support sheet that is not coated). In an embodiment, the non-deposition surface is for handling of the support sheet. In an embodiment, the non-deposition surface is a border on the solid support sheet. In an embodiment, the deposition surface is the entire surface of the solid support sheet. Therefore, in an embodiment, the depositing of the prepolymer composition is on an entire surface of a solid support sheet to form a uniform prepolymer composition layer on the solid support sheet.

Accordingly, in an embodiment, the present application also includes a process of preparing a plurality of porous sorptive solid phase microextraction (SPME) devices comprising:

depositing a prepolymer composition on an entire surface of a solid support sheet to form a uniform prepolymer composition layer on the solid support sheet;

curing the prepolymer composition layer to form a porous sorptive polymer coated sheet; and

cutting the porous sorptive polymer coated sheet to form the plurality of porous sorptive SPME devices.

In an embodiment, the depositing of the prepolymer composition is on substantially an entire surface of solid support sheet to form a substantially uniform prepolymer composition layer on substantially the entire surface of the solid support sheet.

Therefore, in an embodiment, the present application includes a process of preparing a plurality of porous sorptive solid phase microextraction (SPME) devices comprising:

depositing a prepolymer composition on substantially an entire surface of solid support sheet to form a substantially uniform prepolymer composition layer on substantially the entire surface of the solid support sheet;

curing the prepolymer composition layer to form a porous sorptive polymer coated sheet;

optionally, removing non-adhered material from the porous sorptive polymer coated sheet; and

cutting the porous sorptive polymer coated sheet to form the plurality of porous sorptive SPME devices.

In an embodiment, the solid support sheet is formed from any suitable material that is suitable for the deposition of the prepolymer composition and compatible with a sample matrix being analyzed, the analytical device being used, and/or the desorption process being used. In an embodiment, the support sheet is formed of metal, metal alloy, carbon material, paper, wood, glass, plastic, fabric, carbon reinforced polymer or fiber-reinforced plastic, or mixtures thereof.

In an embodiment, the solid support sheet is a carbon material support sheet. In an embodiment, the carbon material is a carbon fiber fabric sheet. In an embodiment, the support sheet is a fused silica support sheet. In an embodiment, the support sheet is a metal alloy support sheet. In an embodiment, the support sheet is a stainless steel, or nickel-titanium alloy support sheet. In an embodiment, the support sheet is a stainless steel, titanium, or a nickel-titanium alloy support sheet. In an embodiment, the support sheet is a fiber-reinforced plastic support sheet. In an embodiment, the fiber-reinforced plastic is a fiberglass support sheet. In an embodiment, the fiberglass support sheet is a fiberglass mesh support sheet. In an embodiment, the support sheet is a stainless steel support sheet or a fiberglass mesh support sheet.

In an embodiment, the support sheet has a thickness that is suitable for the intended use. In an embodiment, the support sheet has a uniform thickness. In an embodiment, the support sheet has a thickness that provides the desired stiffness. In an embodiment, the support sheet is a stainless steel support sheet and has a thickness of about 250 μm to about 1000 μm, about 400 μm to about 1000 μm, about 500 μm to about 1000 μm, about 600 μm to 900 μm, about 700 μm to about 850 μm or about 750 μm to about 820 μm. In an embodiment, the support sheet is a stainless steel support sheet and has a thickness of about 700 μm to about 850 μm, about 750 μm to about 820 μm, about 780 μm to about 810 μm or about 800 μm.

In an embodiment, the fiberglass mesh sheet is comprised of individual fibers, wherein the fibers have a diameter. In an embodiment, the diameter of the fibers is less about 5 μm, less than about 10 μm, less than about 15 μm, less than about 20 μm, or less than about 25 μm. In an embodiment, the diameter of the fibers is less than about 10 μm. In an embodiment, the diameter of the fibers is about 10 μm. In an embodiment, the diameter of the fibers about 2 μm to about 10 μm, or about 3 μm to about 10 μm, about 4 μm to about 9 μm, about 5 μm to about 9 μm, about 5 μm to about 8 μm, about 6 μm to about 9 μm, about 7 μm to about 9 μm, or about 8 μm to about 9 μm.

In an embodiment, the solid support sheet is of any size or shape that is suitable to being uniformly coated with the prepolymer composition, to providing a plurality of SPME devices, and/or is compatible with instruments and/or devices being used in the curing and/or the cutting steps. In an embodiment, the solid support sheet is rectangular or square. In an embodiment, the size of the solid support sheet is compatible for use with a UV curing conveyor system. In an embodiment, the support sheet has a width, and the width is about 5 cm, about 15 cm, about 20 cm, about 25 cm, about 30 cm, about 35 cm, about 40 cm, about 45 cm, about 50 cm, about 55 cm, about 60 cm, about 65 cm, about 75 cm, about 85 cm, about 95 cm, or about 100 cm. In an embodiment, the solid support sheet has a width, and the width is about 15 cm, about 20 cm, about 25 cm, about 30 cm, about 35 cm, about 40cm, about 45 cm, about 50 cm, about 55 cm, about 60 cm, about 65 cm, about 75 cm, or about 85 cm. In an embodiment, the solid support sheet has a width, and the width is about 20 cm, about 25 cm, about 30 cm, or about 35 cm. In an embodiment, the solid support sheet is square. In an embodiment, the solid support sheet is about 20 cm to about 40 cm in width by about 20 cm to about 40 cm in length. In an embodiment, the solid support sheet is about 20 cm to about 30 cm in width by about 20 cm to about 30 cm in length. In an embodiment, the solid support sheet is about 20 cm in width by about 20 cm in length. In an embodiment, the solid support sheet is about 30 cm in width by about 30 cm in length.

In the context of using the solid support sheet with a batch curing system, such as a UV conveyor system, it would be appreciated by a person skilled in the art that the length of the solid support sheet is a length that can be reliably used with such devices.

In an embodiment, when using a flexible solid support sheet (e.g., a solid support sheet that is not stiff), such as a fiberglass mesh support sheet, the fiberglass mesh support sheet may be supported, for example, by a second sheet support with greater stiffness such as a glass or metallic support sheet for ease of handling but that the second support sheet does not form part of the final SPME devices.

In an embodiment, the support sheet is formed of a smooth material such as a metallic material, and the process of the application includes a pretreating step before the step of depositing to, for example, improve the adherence of the polymer coating to the support sheet. Accordingly, in an embodiment, the process further comprises optionally pretreating the support sheet. In an embodiment, the step of pretreating the support sheet comprises cleaning the surface of the support sheet or roughening the surface of the support sheet to be coated or both. In an embodiment, the cleaning is by using water, or an organic solvent or a mixture thereof. In an embodiment, the organic solvent is methanol, acetonitrile, ethanol, isopropyl alcohol or mixtures thereof. In an embodiment, the cleaning by using a commercial degreaser known in the art. In an embodiment, the roughening is by use of an abrasive such as sand paper or a sanding device. In an embodiment, an additional washing step is preformed after the roughening.

In an embodiment, the prepolymer composition comprises a monomer or a mixture of monomers, one or more cross-linking agents, one or more polymer initiators and one or more porogens which are mixed to form the prepolymer composition. Therefore, in an embodiment, the process further comprises mixing a monomer or a mixture of monomers, one or more cross-linking agents, one or more polymer initiators and one or more porogens to produce a prepolymer composition.

In an embodiment, the mixing of the monomer or a mixture of monomers, one or more cross-linking agents, one or more polymer initiators and one or more porogen provides a suspension. In an embodiment, the prepolymer composition is a prepolymer suspension. In an embodiment, the prepolymer composition is a prepolymer homogeneous suspension. In an embodiment, the mixing of the monomer or a mixture of monomers, one or more cross-linking agents, one or more polymer initiators and one or more porogens provides a solution. In an embodiment, the prepolymer composition is a prepolymer solution.

In an embodiment, the prepolymer composition is mixed by any suitably means of mixing known in the art. In an embodiment, the prepolymer composition is mixed by shaking by hand, by using a magnetic stirrer, by sonication, by using a shaker such as a liner, orbital or 3D shaker, by using a multi position stirrer or by using an electric mixer such as vortex mixer.

In an embodiment, the prepolymer composition is further degassed after mixing. Therefore, in an embodiment, the process further comprises degassing the prepolymer composition.

The Applicant has shown that the process of the application is compatible with different prepolymer compositions. For example, the Applicant has prepared a plurality of exemplary sorptive SPME devices using both molecularly imprinted polymer (MIPs) and non-imprinted polymers (NIP) coatings. Therefore, in an embodiment, the prepolymer composition is a MIP or a NIP prepolymer composition. It would be appreciated by a person skilled in the art that the prepolymer composition is selected according to the desired selectivity of the porous sorptive polymer coating, the compatibility of the porous sorptive polymer coating with the sample matrix being analyzed, the curing method being used, the cutting device being used, the analytical device being used, and/or the desorption process being used.

In an embodiment, suitable monomers or mixtures of monomers are selected from methylmethacrylates, other alkyl methacrylates, alkylacrylates, allyl or aryl acrylates and methacrylates, cyanoacrylate, styrene, methyl styrene, vinyl esters such as vinyl acetate, vinyl chloride, methyl vinyl ketone, vinylidene chloride, acrylamide, methacrylamide, acrylonitrile, methacrylonitrile, 2-acetamido acrylic acid, 2-(acetoxyacetoxy)ethyl methacrylate, 1-acetoxy-1,3-butadiene, 2-acetoxy-3-butenenitrile, 4-acetoxystyrene, acrolein, acrolein diethyl acetal, acrolein dimethyl acetal, acrylamide, 2-acrylamidoglycolic acid, 2-acrylamido-2-methyl propane sulfonic acid, acrylic acid, acrylic anhydride, acrylonitrile, acryloyl chloride, (R)-acryloxy-, α,α′-dimethyl-g-butyrolactone, N-acryloxy succinimide-acryloxytris(hydroxymethyl)aminomethane, N-acrylolyl chloride, N-acryloyl pyrrolidinone, N-acryloyl-tris(hydroxymethyl)amino methane, 2-amino ethyl methacrylate, N-(3-aminopropyl) methacrylamide, (o, m, or p)-amino-styrene, t-amyl methacrylate, 2-(1-aziridinyl) ethyl methacrylate, 4-benzyloxy-3-methoxystyrene, 2-bromoacrylic acid, 4-bromo-1-butene, 3-bromo-3,3-difluoropropane, 6-bromo-1-hexene, 3-bromo-2-methacrylonitrile, 2-(bromomethyl) acrylic acid, 8-bromo-1-octene, 5-bromo-1-pentene, cis-1-bromo-1-propene, o-bromostyrene, p-bromostyrene, bromotrifluoro ethylene, (±)-3-buten-2-ol, 1,3-butadiene, 1,3-butadiene-1,4-dicarboxylic acid 3-butenal diethyl acetal, 1-butene, 3-buten-2-ol, 3-butenyl chloroformate, 2-butylacrolein, t-butylacrylamide, butyl acrylate, butyl methacrylate, (o,m,p)-bromostyrene, t-butyl acrylate, (R)-carvone, (S)-carvone, (−)-carvyl acetate, c is 3-chloroacrylic acid, 2-chloroacrylonitrile, 2-chloroethyl vinyl ether, 2-chloromethyl-3-trimethylsilyl-1-propene, 3-chloro-1-butene, 3-chloro-2-chloromethyl-1-propene, 3-chloro-2-methyl propene, 2,2-bis(4-chlorophenyl)-1,1-dichloroethylene, 3-chloro-1-phenyl-1-propene, m-chlorostyrene, o-chlorostyrene, p-chlorostyrene, 1-cyanovinyl acetate, 1-cyclopropyl-1-(trimethylsiloxy) ethylene, 2,3-dichloro-1-propene, 2,6-dichlorostyrene, 1,3-dichloropropene, 2,4-diethyl-2,6-heptadienal, 1,9-decadiene, 1-decene, 1,2-dibromoethylene, 1,1-dichloro-2,2-difluoroethylene, 1,1-dichloropropene, 2,6-difluorostyrene, dihydrocarveol, (±)-dihydrocarvone, (−)-dihydrocarvyl acetate, 3,3-dimethylacrylaldehyde, N,N′-dimethylacrylamide, 3,3-dimethylacrylic acid, 3,3-dimethylacryloyl chloride, 2,3-dimethyl-1-butene, 3,3-dimethyl-1-butene, 2-dimethyl aminoethyl methacrylate, 1-(3-butenyl)-4-vinylbenzene, 2,4-dimethyl-2,6-heptadien-1-ol, 2,4-dimethyl-2,6-heptadienal, 2,5-dimethyl-1,5-hexadiene, 2,4-dimethyl-1,3-pentadiene, 2,2-dimethyl-4-pentenal, 2,4-dimethylstyrene, 2,5-dimethylstyrene, 3,4-dimethylstryene, 1-dodecene, 3,4-epoxy-1-butene, 2-ethyl acrolein, ethyl acrylate, 2-ethyl-1-butene, (±)-2-ethylhexyl acrylate, (±)-2-ethylhexyl methacrylate, 2-ethyl-2-(hydroxymethyl)-1,3-propanediol triacrylate, 2-ethyl-2-(hydroxymethyl)-1,3-propanediol trimethacrylate, ethyl methacrylate, ethyl vinyl ether, ethyl vinyl ketone, ethyl vinyl sulfone, (1-ethylvinyl)tributyl tin, m-fluorostyrene, o-fluorostyrene, p-fluorostyrene, glycol methacrylate (hydroxyethyl methacrylate), GA GMA, 1,6-heptadiene, 1,6-heptadienoic acid, 1,6-heptadien-4-ol, 1-heptene, 1-hexen-3-ol, 1-hexene, hexafluoropropene, 1,6-hexanediol diacrylate, 1-hexadecene, 1,5-hexadien-3,4-diol, 1,4-hexadiene, 1,5-hexadien-3-ol, 1,3,5-hexatriene, 5-hexen-1,2-diol, 5-hexen-1-ol, hydroxypropyl acrylate, 3-hydroxy-3,7,11-trimethyl-1,6, 10-dodecatriene, isoamyl methacrylate, isobutyl methacrylate, isoprene, 2-isopropenylaniline, isopropenyl chloroformate, 4,4′-isopropylidene dimethacrylate, 3-isopropyl-a-a-dimethylbenzene isocyanate, isopulegol, itaconic acid, itaconalyl chloride, (±)-:linalool, linalyl acetate, p-mentha-1,8-diene, p-mentha-6,8-dien-2-ol, methyleneamino acetonitrile, methacrolein, [3-(methacryloylamino)-propyl]trimethylammonium chloride, methacrylamide, methacrylic acid, methacrylic anhydride, methacrylonitrile; methacryloyl chloride; 2-(methacryloyloxy)ethyl acetoacetate; (3-methacryloxypropyl)trimethoxy silane; 2-(methacryloxy) ethyl trimethyl ammonium methylsulfate; 2-methoxy propene (isopropenyl methyl ether); methyl-2-(bromomethyl)acrylate; 5-methyl-5-hexen-2-one; methyl methacrylate; N,N′-methylene bisacrylamide; 2-methylene glutaronitrite; 2-methylene-1,3-propanediol, 3-methyl-1,2-butadiene, 2-methyl-1-butene, 3-methyl-1-butene, 3-methyl-1-buten-1-ol, 2-methyl-1-buten-3-yne, 2-methyl-1,5-heptadiene, 2-methyl-1-heptene, 2-methyl-1-hexene, 3-methyl-1,3-pentadiene, 2-methyl-1,4-pentadiene, (±)-3-methyl-1-pentene, (±)-4-methyl-1-pentene, (±)-3-methyl-1-penten-3-ol, 2-methyl-1-pentene, -methyl styrene, t-methylstyrene, t-methylstyrene, 3-methylstyrene, methyl vinyl ether, methyl vinyl ketone, methyl-2-vinyloxirane, 4-methylstyrene, methyl vinyl sulfone, 4-methyl-5-vinylthiazole, myrcene, t-nitrostyrene, 3-nitrostyrene, 1-nonadecene, 1,8-nonadiene, 1-octadecene, 1,7-octadiene, 7-octene-1,2-diol, 1-octene, 1-octen-3-ol, 1-pentadecene, 1-pentene, 1-penten-3-ol, t-2,4-pentenoic acid, 1,3-pentadiene, 1,4-pentadiene, 1,4-pentadien-3-ol, 4-penten-1-ol, 4-penten-2-ol, 4-phenyl-1-butene, phenyl vinyl sulfide, phenyl vinyl sulfonate, 2-propene-1-sulfonic acid sodium salt, phenyl vinyl sulfoxide, 1-phenyl-1-(trimethylsiloxy) ethylene, propene; safrole; styrene (vinyl benzene); 4-styrene sulfonic acid sodium salt; styrene sulfonyl chloride; 3-sulfopropyl acrylate potassium salt; 3-sulfopropyl methacrylate sodium salt; tetrachloroethylene; tetracyano ethylene; trans 3-chloroacrylic acid; 2-trifluoromethyl propene; 2-(trifluoromethyl)propenoic acid; 2,4,4′-trimethyl-1-pentene; 3,5-bis(trifluoromethyl)styrene, 2,3-bis(trimethylsiloxy)-1,3-butadiene, 1-undecene, vinyl acetate, vinyl acetic acid, 4-vinyl anisole, 9-vinyl anthracene, vinyl behenate, vinyl benzoate, vinyl benzyl acetate, vinyl benzyl alcohol, 3-vinyl benzyl chloride, 3-(vinyl benzyl)-2-chloroethyl sulfone, 4-(vinyl benzyl)-2-chloroethyl sulfone, N-(p-vinyl benzyl)-N,N′-dimethyl amine, 4-vinyl biphenyl (4-phenyl styrene), vinyl bromide, 2-vinyl butane, vinyl butyl ether, 9-vinyl carbazole, vinyl carbinol, vinyl cetyl ether, vinyl chloroacetate, vinyl chloroformate, vinyl crotanoate, vinyl cyclohexane, 4-vinyl-1-cyclohexene, 4-vinylcyclohexene dioxide, vinyl cyclopentene, vinyl dimethylchlorosilane, vinyl dimethylethoxysilane, vinyl diphenylphosphine, vinyl 2-ethyl hexanoate, vinyl 2-ethylhexyl ether, vinyl ether ketone, vinyl ethylene, vinyl ethylene iron tricarbonyl, vinyl ferrocene, vinyl formate, vinyl hexadecyl ether, vinylidene fluoride, 1-vinyl imidizole, vinyl iodide, vinyl laurate, vinyl magnesium bromide, vinyl mesitylene, vinyl 2-methoxy ethyl ether, vinyl methyl dichlorosilane, vinyl methyl ether, vinyl methyl ketone, 2-vinyl naphthalene, 5-vinyl-2-norbornene, vinyl pelargonate, vinyl phenyl acetate, vinyl phosphonic acid, bis(2-chloroethyl)ester, vinyl propionate, 4-vinyl pyridine, 2-vinyl pyridine, 1-vinyl-2-pyrrolidinone, 2-vinyl quinoline, 1-vinyl silatrane, vinyl sulfone, vinyl sulfonic acid sodium salt, o-vinyl toluene, p-vinyl toluene, vinyl triacetoxysilane, vinyl tributyl tin, vinyl trichloride, vinyl trichlorosilane, vinyl trichlorosilane (trichlorovinylsilane), vinyl triethoxysilane, vinyl triethylsilane, vinyl trifluoroacetate, vinyl trimethoxy silane, vinyl trimethyl nonylether, vinyl trimethyl silane, vinyl triphenyphosphonium bromide (triphenyl vinyl phosphonium bromide), vinyl tris-(2-methoxyethoxy)silane, and vinyl 2-valerate.

In an embodiment, the monomer or a mixture of monomers is selected from acrylic acid (AA), methacrylic acid (MAA), 2-(trifluoromethyl)acrylic acid (TFMAA), itaconic acid, p-vinylbenzoic acid, 2-acrylamido-2-methyl-1-propanesulfonic acid (AMPSA), 4-vinylbenzeneboronic acid, 2-vinylpyridine (2-VP), 4- vinylpyridine (4-VP), N,N-(diethylaminoethy methacrylate) (DEAEM), 1-vinylimidazolo allylamine, 1-vinylimidazole, 4-(5)-vinylimidazole, N-(2-aminethyl)-methacrylamide, N,N′-diethyl-4-styrylamidine, N,N,N-trimethylaminoethylmethacrylate, N-vinylpyrrolidone (NVP), urocanic ethyl ester, methyl methacrylate (MMA), 2-hydroxyethyl methacrylate (2-HEMA), 4-ethylstyrene, acrylamide, methacrylamide, trans-3-(3-pyridyl)-acrylic acid, acrylonitrile and styrene.

In an embodiment, the monomer or mixture or monomers is selected from acrylic acid (AA), methacrylic acid (MAA), trifluoromethyl acrylic acid (TFMAA), methyl methacrylate (MMA), p-vinylbenzoic acid, itaconic acid, 4-ethylstyrene, styrene, 2-vinylpyridine (2-VP), 4-vinylpyridine (4-VP), 1-vinylimidazole, acrylamide, methacrylamide, 2-acrylamido-2-methyl-1-propane sulfonic acid, 2-hydroxyethyl methacrylate (2-HEMA) and trans-3-(3-pyridyl)-acrylic acid. In an embodiment, the monomer or a mixture of monomers is selected from 4-vinyl pyridine (4-VP) and methacrylic acid (MAA).

Cross linking agents are known to those skilled in the art. In an embodiment, the one or more cross-linking agents is selected from di-, tri- and tetrafunctional acrylates or methacrylates, divinylbenzene (DVB), alkylene glycol and polyalkylene glycol diacrylates and methacrylates, including ethylene glycol dimethacrylate (EGDMA) and ethylene glycol diacrylate, vinyl or allyl acrylates or methacrylates, divinylbenzene, diallyldiglycol dicarbonate, diallyl maleate, diallyl fumarate, diallyl itaconate, vinyl esters such as divinyl oxalate, divinyl malonate, diallyl succinate, triallyl isocyanurate, the dimethacrylates or diacrylates of bis-phenol A or ethoxylated bis-phenol A, methylene or polymethylene bisacrylamide or bismethacrylamide, such as hexamethylene bisacrylamide or hexamethylene bismethacrylamide, di(alkene) tertiary amines, trimethylol propane triacrylate, pentaerythritol tetraacrylate, divinyl ether, divinyl sulfone, diallyl phthalate, triallyl melamine, 2-isocyanatoethyl methacrylate, 2-isocyanatoethylacrylate, 3-isocyanatopropylacrylate, 1-methy:L-2-isocyanatoethyl methacrylate, 1, 1-dimethyl-2-isocyanaotoethyl acrylate, tetraethylene glycol diacrylate, tetraethylene glycol dimethacrylate, triethylene glycol diacrylate, triethylene glycol dimethacrylate, hexanediol dimethacrylate, hexanediol diacrylate, divinyl benzene; 1,3-divinyltetramethyl disiloxane; 8, 13-divinyl-3,7, 12, 17-tetramethyl-21H,23H-porphine, 8,13-divinyl-3,7, 12, 17-tetramethyl-21H,23H-propionic acid, 8, 13-divinyl-3,7, 12, 17-tetramethyl-21H,23H-propionic acid disodium salt, 3,9-divinyl-2,4,8, 10-tetraoraspiro[5,5]undecane and divinyl tin dichloride.

In an embodiment, the one or more cross linking agents are selected from ethylene glycol dimethacrylate (EGDMA) N,O-bismethacryloyl ethanolamine, N,N′-methylenebisacrylamide (MDAA), p-divinylbenzene (DVB), N,N′-1,3-phenylenebis(2-methyl-2-propenamide) (PDBMP), 3,5-bisacryloylamido benzoic acid, N,O-bisacryloyl-L-phenylalaninol, 1,3-diisopropenyl benzene (DIP), pentaerythritol triacrylate (PETRA), pentaerythritol pentacrylate (PRTEA), triethylolpropane trimethacrylate (TRIM), tetramethylene dimethacrylate (TDMA), 2,6-bisacryloylamidopyridine, 1,4-phenylene diacrylamide, 1,4-diacryloyl piperazine (DAP), N,N′ -ethylenebismethacrylamide, N,N′-tetramethylenebismethacrylamide, N,N′-hexamethylenebismethacrylamide, anhydroerythritoldimethacrylate and 1,4,3,6-dianhydro-D-sorbitol-2,5-dimethacrylate and mixtures thereof. In an embodiment, cross linking agent is ethylene glycol dimethacrylate (EGDMA).

In an embodiment, the one or more porogens are selected from toluene, xylene, methoxyethanol, chlorinated solvents such as dichloromethane, ethyl acetate, benzyl alcohol, 1-octanol, cyclohexane, isopropanol and acetonitrile, polyethylene glycol, water and mixtures thereof. In an embodiment, the one or more porogens are selected from toluene, xylene, methoxyethanol, chlorinated solvents such as dichloromethane, ethyl acetate, benzyl alcohol, 1-octanol, dodecyl alcohol cyclohexane, isopropanol and acetonitrile, polyethylene glycol, water and mixtures thereof. In an embodiment, the porogen is 1-octanol.

In an embodiment, the porogen is polyethylene glycol. In an embodiment, the polyethylene glycol is high molecular weight polyethylene glycol or low molecular weight polyethylene glycol. In an embodiment, the high molecular weight polyethylene glycol is polyethylene glycol 20,000 (PEG 20,000). In an embodiment, the low molecular weight polyethylene glycol is polyethylene glycol 200 (PEG 200). In an embodiment, the porogen is a mixture comprising high molecular weight polyethylene glycol and one or more other porogens as described above. In an embodiment, the porogen is a mixture comprising high molecular weight polyethylene glycol and methanol, water or acetonitrile.

Polymer initiators are also well known to those skilled in the art. In an embodiment, the choice of polymer initiators will depend, for example, on the choice of monomer and cross-linking agents being used, and curing conditions. In an embodiment, the polymer initiator is a photo-initiator. In an embodiment, the polymer initiator is a mixture of polymer initiators. In an embodiment, the one or more polymer initiators are selected from benzoyl peroxide, acetyl peroxide, lauryl peroxide, azobisisobutyronitrile (AIBN), t-butyl peracetate, cumyl peroxide, t-butyl peroxide; t-butyl hydroperoxide, bis(isopropyl)peroxy-dicarbonate, benzoin methyl ether, 2,2′-azobis(2,4-dimethylvaleronitrile), tertiarybutyl peroctoate, phthalic peroxide, diethoxyacetophenone and tertiarybutyl peroxypivalate, diethoxyacetophenone, 1-hydroxycyclohexyl phenyl ketone, 2,2-dimethyoxy-2-phenylacetophenone (DMPA), phenothiazine, diisopropylxanthogen disulfide, 2,2′-azobis-(2-amidinopropane); 2,2′-azobisisobutyronitrile, 4,4′-azobis-(4-cyanovaleric acid), 1,1′-azobis-(cyclohexanecarbonitrile), 2,2′-azobis-(2,4-dimethylvaleronitrile) (ABDV), and mixtures thereof.

In an embodiment, the one or more suitable polymer initiators are selected from azobisisobutyronitrile (AIBN), azobisdimethylvaleronitrile (ABDV), 2,2-dimethoxy-2-phenylacetophenone (DMPA), benzoylperoxide (BPO) and 4,4′ -azo(4-cyanovaleric acid) and mixtures thereof. In an embodiment, the polymer initiator is 2,2-dimethoxy-2-phenylacetophenone (DMPA).

In an embodiment, the polymer on the porous sorptive polymer coated sheet is a molecularly imprinted polymer (MIP) or a non-molecularly imprinted polymer (NIP). In an embodiment, the polymer on the polymer coated sheet is a molecularly imprinted polymer (MIP). Therefore, in an embodiment, the prepolymer composition further comprises one more template molecules.

In an embodiment, the selection of template molecules in a MIP would depend, for example, on the intended use of the MIP and the solubility of the template molecule in the prepolymer composition. In an embodiment, the one or more template molecules are soluble in the prepolymer composition. In an embodiment, the one or more template molecules is a target molecule, an analogue thereof with similar chemistry and shape, and/or a compound that has functionality and shape close to the target molecule. In an embodiment, the one or more template molecules are selected from 2-{[diethoxy(sulfanylidene)-λ-phosphanyl]amino}acetic acid, O,O′-diethyl chlorothiophosphate, diphenyl chlorophosphate, 2-[(diphenoxyphosphoryl)amino]acetic acid, 4-{[diethoxy (sulfanylidene)-λ-phosphanyl]amino}butanoic acid, 4-[(diphenoxyphosphoryl)amino]butanoic acid, carbamazepine, benzyl (3-(10,11-dihydro-5H-dibenzo[b,f]azepin-5-yl)propyl)(methyl)carbamate (CBZ-desipramine). In an embodiment, the template molecule is 2-{[diethoxy(sulfanylidene)-λ-phosphanyl]amino}acetic acid.

In an embodiment, the target molecule is a drug of abuse, a tricyclic antidepressant, an organophosphorus pesticides (OPP), a polycyclic aromatic hydrocarbon (PAH), and mixtures thereof. In an embodiment, the target molecule is mycophenolate.

In an embodiment, the OPP is selected from demeton-S-methyl, ethoprophos, parathion methyl, tolcofos methyl, methidathion, fenamiphos, diazinon, pirimiphos methyl, disulfoton sulfone, azynphos-methyl, malathion, prothiofos, chlorpyrifos, tetrachlorvinphos, profenofos, pyrazophos, ethion, dichlorvos, phosmet, fenitrothion, azamethiphos and terbufos, and mixtures thereof.

In an embodiment, the PAH is selected from naphthalene, anthracene, phenanthrene, phenalene, tetracene, chrysene, triphenylene, pyrene, pentacene, benzo[a]pyrene, corannulene, benzo[ghi]perylene, coronene, ovalene and benzo[c]fluorine, and mixtures thereof.

In an embodiment, the tricyclic antidepressant is selected from amitriptyline, imipramine, clomipramine, desipramine, doxepin, trimipramine and nortriptyline, and mixtures thereof.

In an embodiment, the drug of abuse is selected from cocaine, amphetamine, methamphetamine, methylenedioxymethamphetamine (MDMA), flunitrazepam, gamma-hydroxybutyrate, mescaline, psilocybin, ketamine, phencyclidine, dextromethorphan, lysergic acid diethylamide, methadone, Central Nervous System (CNS) depressants, stimulants and opioid pain relievers, and mixtures thereof.

In an embodiment, the CNS depressant is selected from benzodiazepines such as diazepan, clonazepam, alprazolam, or triazolam, non-benzodiazepine compounds such as zolpidem, eszopiclone, or zaleplon and barbiturates, such as mephobarbital, phenobarbital and pentobarbital sodium and mixtures thereof.

In an embodiment, the stimulant is dextroamphetamine or methylphenidate.

In an embodiment, the opioid is codeine, morphine, methadone or fentanyl, oxycodone, hydrocodone, hydromorphone, oxymorphone, meperidine or propoxyphene.

In an embodiment, the prepolymer composition further comprises an additive. In an embodiment, the additive is a plasticizer, a pigment, a thermal stabilizer, an anti-static agent, a heat (thermal) and/or light stabilizer, a filler and a fiber reinforcement. In an embodiment, the plasticizer is a phthalate, a chlorinate paraffin or an adipate.

In an embodiment, the heat (thermal) stabilizer is a brominated flame retardant such as polybrominate diphenylethers, or a phosphorous thermal stabilizer such as tris (2-chloroethyl)phosphate or triphenylphosphine (TPP). In an embodiment, the thermal stabilizer is triphenylphosphine (TPP).

In an embodiment, the anti-static agent is glycerol monostearate. In an embodiment, the filler is calcium carbonate, zinc oxide, or talc. In an embodiment, the fiber reinforcement is carbon, aramid or glass. In an embodiment, the heat stabilizer is an anti-oxidant such as octylphenol. In an embodiment, the light stabilizer is an oxanilide, a benzophenone or a benzotriazole. In an embodiment, the additive is a sorptive particle that improves the extraction efficiency of the devices.

In an embodiment, particles are added to the prepolymer composition to enhance adsorption capacity. Accordingly, in an embodiment, the prepolymer composition further comprises particles. In an embodiment, the prepolymer composition further comprises particles for enhancing adsorption capacity. In an embodiment, the particles are nanoparticles. In an embodiment, the nanoparticles are selected from metal nanoparticles (e.g., gold and silver), metal oxides (e.g., TiO₂, ZnO, ZrO₂, Al₂O₃ and CeO₂), magnetic nanoparticles (e.g., Fe₃O₄ and Fe₃O₄ coated with SiO₂), carbon nanomaterials (carbon nanotubes, C18, graphene), silica nanoparticles, metal organic frameworks (MOFs) and covalent organic frameworks (COFs).

In an embodiment, the monomer is methacrylic acid or a vinyl pyridine. In an embodiment, the monomer is methacrylic acid. In an embodiment, the monomer is a vinylpyridine. In an embodiment, the cross linking agent is a methacrylate.

In an embodiment, the monomer is methacrylic acid (MAA), 2-vinylpyridine (2-VP), or 4-vinylpyridine (4-VP) and the cross linking agent a is selected from ethylene glycol dimethacrylate (EGDMA) triethylolpropane trimethacrylate (TRIM), tetramethylene dimethacrylate (TDMA), anhydroerythritoldimethacrylate and 1,4,3,6-dianhydro-D-sorbitol-2,5-dimethacrylate and mixtures thereof.

In an embodiment, the prepolymer composition comprises a monomer or a mixture of monomers, a cross-linking agent, a polymer initiator and a porogen wherein the monomer is 4-VP or MAA, the crosslinking agent is EGDMA, the polymer initiator is DMPA and the porogen is 1-octanol. In an embodiment, the monomer is 4-VP, the crosslinking agent is EGDMA, the polymer initiator is DMPA and the porogen is 1-octanol. In an embodiment, the monomer is MAA, the crosslinking agent is EGDMA, the polymer initiator is DMPA and the porogen is 1-octanol. In an embodiment, the monomer is MAA, the crosslinking agent is EGDMA, the polymer initiator is DMPA, the porogen is 1-octanol and the template molecule is 2-{[diethoxy(sulfanylidene)-λ-phosphanyl]amino}acetic acid.

In an embodiment, the prepolymer composition is a composition of Formula I, Formula II, Formula II a-d, Formula III or Formula IV. In an embodiment, the prepolymer composition is a composition of Formula I or Formula II and the solid support sheet is a metallic (e.g. stainless steel) sheet. In an embodiment, the prepolymer composition is a composition of Formula III or Formula IV and the solid support is a fiberglass mesh sheet.

In an embodiment, the ratio of monomer to cross-linking agent is any suitable ratio of monomer to cross-linking agent that provides a polymer coating of suitable porosity and integrity.

In an embodiment, the molar ratio of monomer or mixture of monomers to crosslinking agent is about 1:15 to about 1:1, about 1:14 to about 1:1, about 1:13 to about 1:1, 1:12 to about 1:1, 1:11 to about 1:1, about 1:10 to about 1:1, about 1:9 to about 1:1, 1:15 to about 1:4, about 1:14 to about 1:4, about 1:14 to about 1:6, about 1:15 to about 1:4. About 1:8 to about 1:2, about 1:8 to about 1:3, or about 1:6 to about 1:4. In an embodiment, the molar ratio of monomer or mixture of monomers to cross-linking agent is about 1:15, about 1:14, about 1:13, about 1:12, about 1:11, about 1:10, about 1:9, about 1:8, about 1:7, about 1:6, about 1:5, about 1:4, about 1:3, about 1:2 or about 1:1. In an embodiment, the molar ratio of monomer or mixture of monomers to cross-linking agent is about 1:15 to about 1:4, about 1:14 to about 1:4, about 1:14 to about 1:6, about 1:15 to about 1:4. About 1:8 to about 1:2, about 1:8 to about 1:3, or about 1:6 to about 1:4. In an embodiment, the molar ratio of monomer or mixture of monomers to cross-linking agent is about 1:6 to about 1:4. In an embodiment, the ratio of monomer or mixture of monomers to cross. In an embodiment, the molar ratio of monomer or mixture of monomers to cross-linking agent is about 1:6. In an embodiment, the ratio of monomer or mixture of monomers to cross-linking agent is about 1:5. In an embodiment, the molar ratio of monomer or mixture of monomers to cross-linking agent is about 1:4.

In an embodiment, the molar ratio of template molecule if present to monomer or mixture of monomers is about 1:20 to about 1:1, about 1:18 to about 1:1, about 1:16 to about 1:1, about 1:14 to about 1:1, about 1:12 to about 1:1, about 1:10 to about 1:1, about 1:8 to about 1:2, about 1:6 to about 1:2, about 1:4 to about 1:2, about 1:6 to about 1:3, about 1:5 to about 1:3, about 1:8 to about 1:4, or about 1:6 to about 1:4. In an embodiment, the molar ratio of template molecule if present to monomer or mixture of monomers is about 1:16 to about 1:1, about 1:14 to about 1:1, about 1:12 to about 1:1, about 1:10 to about 1:1, about 1:8 to about 1:2, about 1:6 to about 1:2, about 1:4 to about 1:2, 1:6 to about 1:3, about 1:5 to about 1:3, about 1:8 to about 1:4, or about 1:6 to about 1:4. In an embodiment, the molar ratio of template molecule to monomer or mixture of monomers is about 1:16. In an embodiment, the molar ratio of template molecule to monomer or mixture of monomers is about 1:6. In an embodiment, the molar ratio of template molecule to monomer or mixture of monomers is about 1:5. In an embodiment, the molar ratio of template molecule to monomer or mixture of monomers is about 1:3. In an embodiment, the molar ratio of template molecule to monomer or mixture of monomers is about 1:4.

In an embodiment, the monomer is present in an amount of about 1% (v/v) to about 10% (v/v), about 1% (v/v) to about 9% (v/v), about 1% (v/v) to about 8% (v/v), about 1% (v/v) to about 7% (v/v), about 2% (v/v) to about 7% (v/v), about 2% (v/v) to about 6% (v/v), about 2% (v/v) to about 5% (v/v), or about 3% (v/v) to about 5% (v/v); or about 1% (v/v), about 2% (v/v), about 3% (v/v), about 4% (v/v), about 5% (v/v), about 6% (v/v), about 7% (v/v), about 8% (v/v), about 9% (v/v) or about 10% (v/v) of the prepolymer composition. In an embodiment, the monomer is present in an amount of about 2% (v/v) to about 6% (v/V), about 2% (v/v) to about 5% (v/v), or about 3% (v/v) to about 5% (v/v); or about 3% (v/v), about 4% (v/v), about 5% (v/v), or about 6% (v/v) of the prepolymer composition.

In an embodiment, the cross-linking agent is present in an amount of about 20% (v/v) to about 60% (v/v), about 30% (v/v) to about 50% (v/v), or about 40% (v/v) to about 50% (v/v), or about 20% (v/v) to about 30% (v/v), about 40% (v/v), about 45% (v/V), about 50% (v/v) or about 60% (v/v) of the prepolymer composition. In an embodiment, the cross-linking agent is present in an amount of about 40% (v/v) to about 50% (v/v); or about 40% (v/v), about 45% (v/v), or about 50% (v/v) of the prepolymer composition.

In an embodiment, the solvent is present in an amount of about 20% (v/v) to about 60% (v/v), about 30% (v/v) to about 60% (v/v), about 40% (v/v) to about 60% (v/v), or about 50% (v/v) to about 60% (v/v), or about 40% (v/v), about 45% (v/v), about 50% (v/V), about 55% (v/v) or about 60% (v/v) of the prepolymer composition. In an embodiment, the cross-linking agent is present in an amount of about 40% (v/v) to about 60% (v/v), or about 50% (v/v) to about 60% (v/v), or about 50% (v/v), or about 55% (v/v) of the prepolymer composition.

In an embodiment, the depositing is by any suitable method of depositing a prepolymer composition on a solid support sheet to form a uniform prepolymer composition layer known in the art. For example, in an embodiment, the depositing is by dipping, spreading, brush painting, drop-casting and spraying. In an embodiment, the depositing is by drop-casting. In an embodiment, the depositing is by spraying. In an embodiment the depositing is by spray coating.

In an embodiment, the depositing is to a deposition surface (e.g., a surface to be coated) on the solid support sheet. In an embodiment, the depositing is to an entire surface of the solid support sheet. In an embodiment, the depositing is to an entire upper surface (e.g., one side) of the solid support sheet. In an embodiment, when the depositing is by dipping, the depositing is to one or both surfaces (or sides) of the support sheet.

In the context of the prepolymer composition layer, the term “uniform” refers to a prepolymer composition layer of a thickness that varies by less than 5% on the support sheet.

The Applicant has shown that it is advantageous to deposit the prepolymer composition by spraying, such as by spray coating. Therefore, in an embodiment, the step of depositing is by spraying. In an embodiment, the amount of prepolymer composition that is sprayed is controlled by varying the pressure and time of spraying. In an embodiment, the spraying, for example spray coating, provides a uniform prepolymer composition layer and polymer coating layer using only one depositing (e.g., spraying) and curing procedure.

Accordingly, the present application also includes a process of preparing a plurality of porous sorptive solid phase microextraction (SPME) devices comprising:
spraying a prepolymer composition on a surface of a solid support sheet to form a uniform prepolymer composition layer on the solid support sheet;
curing the prepolymer composition layer to form a porous sorptive polymer coated sheet; and
cutting the porous sorptive polymer coated sheet to form the plurality of sorptive SPME devices.

In an embodiment, the spraying is to a deposition surface of the solid support sheet. In an embodiment, the spraying is to an entire surface of the solid support sheet. Therefore, in an embodiment, the spraying of the prepolymer composition is on an entire surface of a solid support sheet to form a uniform prepolymer composition layer on the solid support sheet.

Accordingly, in an embodiment, the present application also includes a process of preparing a plurality of porous sorptive solid phase microextraction (SPME) devices comprising:
spraying a prepolymer composition on an entire surface of a solid support sheet to form a uniform prepolymer composition layer on the solid support sheet;
curing the prepolymer composition layer to form a porous sorptive polymer coated sheet; and
cutting the porous sorptive polymer coated sheet to form the plurality of porous sorptive SPME devices.

In an embodiment, the porous sorptive polymer coated sheet comprises a sorptive polymer coating layer on the solid support sheet. In an embodiment, the porous sorptive polymer coated sheet comprises a uniform sorptive polymer coating layer on the solid support sheet.

In an embodiment, the spraying of the prepolymer composition is on substantially an entire surface of solid support sheet to form a substantially uniform prepolymer composition layer on substantially the entire surface of the solid support sheet.

Therefore, in an embodiment, the present application includes a process of preparing a plurality of porous sorptive solid phase microextraction (SPME) devices comprising:
spraying a prepolymer composition on substantially an entire surface of solid support sheet to form a substantially uniform prepolymer composition layer on substantially the entire surface of the solid support sheet;
curing the prepolymer composition layer to form a porous sorptive polymer coated sheet;
optionally, removing non-adhered material from the porous sorptive polymer coated sheet; and

cutting the porous sorptive polymer coated sheet to form the plurality of porous sorptive SPME devices.

In an embodiment, the spraying is by spray coating. Therefore, in an embodiment, the process comprises spray coating a prepolymer composition on an entire surface of a solid support sheet to form a uniform polymer coating layer on the solid support sheet.

In an embodiment, the process comprises spray coating a prepolymer composition on substantially an entire surface of a solid support sheet to form a substantially uniform polymer coating layer on substantially the entire surface of the solid support sheet.

In an embodiment, the spray coating is performed using any suitable means of spray coating known in the art. In an embodiment, the spray coating is performed using a commercially available paint sprayer. In an embodiment, the sprayer is a high volume low pressure (HVLP) sprayer or a high pressure low volume HPLV sprayer. In an embodiment, the sprayer is an airless sprayer.

In an embodiment, the step of depositing or spraying is under any conditions to form a uniform prepolymer composition layer on solid support sheet. In an embodiment, the step of depositing or spraying is under any conditions to form a substantially uniform prepolymer composition layer on substantially the entire surface of the solid support sheet.

In an embodiment, the conditions to form the uniform prepolymer composition layer comprise, for example, a suitable temperature, spray rate, air pressure, spray nozzle diameter of a sprayer, a composition carrier and/or distance from the surface of the solid support sheet.

In an embodiment, the air pressure for the spraying is about 10 psi to about 50 psi, about 10 psi to about 40 psi, about 20 psi to about 40 psi, about 25psi to about 40 psi, about 25 psi to about 35 psi, or about 28 psi to about 33 psi. In an embodiment, the air pressure is about 25 psi to about 40 psi, about 25 psi to about 35 psi, or about 28 psi to about 33 psi. In an embodiment, the air pressure is about 25 psi to about 40 psi, about 25 psi to about 35 psi, or about 28 psi to about 33 psi. In an embodiment, the air pressure is about 30 psi.

In an embodiment, the carrier for the spraying is compressed air or nitrogen or argon. In an embodiment, the carrier is nitrogen.

In an embodiment, the spray coating is performed from a distance of about 10 cm to about 55 cm, or 15 cm to about 45 cm from the support sheet. In an embodiment, the spray coating is performed from a distance of about or 15 cm to about 45 cm from the support sheet.

In an embodiment, the thickness of the uniform prepolymer composition layer is determined by, for example, the composition of the prepolymer composition and the number and length of time of depositing steps.

In an embodiment, the step of depositing or spraying is repeated to obtain thickness of the uniform prepolymer composition layer that will result in the desired final thickness of the porous sorptive polymer coating layer. In an embodiment, the uniform prepolymer composition layer is obtained by a single depositing step. In an embodiment, the uniform prepolymer composition layer is obtained using two or more depositing steps. In an embodiment, the uniform prepolymer composition layer is obtained using two depositing steps. Therefore, in an embodiment, the step of depositing is optionally repeated. In an embodiment, the step of depositing is optionally repeated 2 to 5 time, 2 to 4 or 2 to 3 times. In an embodiment, the step of depositing is not repeated.

In the context of the present application, the phrase “an entire surface” would be understood to mean “nearly completely an entire surface”. For example, a surface which is entirely covered with a prepolymer composition layer would be understood to mean a surface which is “nearly completely” covered, but which may include insignificant amounts of non-coverage.

In an embodiment, the step of curing of the prepolymer composition layer occurs after the depositing of the prepolymer composition on the support sheet. Accordingly, in an embodiment, the uniform prepolymer composition layer is polymerized while on the support sheet to form the porous sorptive polymer coated sheet. In an embodiment, the curing of the uniform prepolymer composition layer is by heating (thermal activation) or by photopolymerization which is photo-initiated by ultraviolet (UV) radiation (UV curing). Therefore, in an embodiment, the curing is by thermal activation. Alternatively, in an embodiment, the curing is by photopolymerization. In an embodiment, the photopolymerization is initiated by UV radiation. Therefore, in an embodiment, the curing is UV curing. In an embodiment, the UV curing is performed using an UV curing conveyor system.

In an embodiment, the uniform prepolymer composition layer is cured under any suitable conditions to form the porous sorptive polymer coated sheet. In an embodiment, the step of curing is performed, for example, at a suitable temperature, for a suitable length of exposure time, and using a suitable radiation wavelength and atmosphere, the selection of each of which is within the purview of those skilled in the art.

In an embodiment, the step of curing is performed for about 1 minute to about 45 minutes, about 1 minute to about 30 minutes, or about 30 minutes or less. In an embodiment, the step of curing is performed for about one minute or less, or about 30 seconds to about 1 minute.

In an embodiment, the step of curing is by UV curing using a UV lamp or a full spectrum lamp. In an embodiment, the step of curing is UV curing using radiation at a wavelength of about 100 nm to about 400 nm, 150 nm to about 305 nm, about 100 nm to about 280 nm, about 280 nm to about 315 nm, or about 315 nm to about 400 nm. In an embodiment the step of curing comprises UV curing using radiation at a wavelength of 254 nm. In an embodiment the step of curing comprises UV curing using radiation at a wavelength of 365 nm. In an embodiment, the step of curing comprises UV curing using full spectrum UV radiation. Surprisingly, the Applicants have found that when using DMPA as the polymer initiator, UV curing could be done using radiation at 254 nm. In an embodiment, when using DMPA as the polymer initiator, the step of curing comprises UV curing using radiation at a wavelength of 254 nm.

In an embodiment, the step of curing is UV curing and the UV curing is performed at ambient temperature. In an embodiment, the UV curing is performed at about 18° C. to about 25° C. It would be appreciated by a person skilled in the art that the UV lamp used in the UV curing may produce heat with may provide a localized increase in temperature over the curing surface.

In an embodiment, the step of curing is performed under inert atmosphere. In an embodiment, the step of curing is UV curing and is performed under an inert atmosphere. In an embodiment, the inert atmosphere is a nitrogen atmosphere.

The Applicant has shown that when a fiberglass mesh support sheet is used the step of curing occurs at an accelerated rate in comparison to when a metallic support sheet is used. Without wishing to be bound by theory, the surface of the fiberglass mesh support sheet comprises a greater surface area and provides for more adhesion of prepolymer composition to fiber glass sheets.

Accordingly, in an embodiment, the solid support sheet is a solid fiberglass mesh support sheet and the step of curing is performed for 30 seconds to about 1 minute. In an embodiment, the solid support sheet is a solid stainless steel support sheet and the the step of curing is performed for about 30 minutes.

In an embodiment, the step of curing comprises a polymerization induced phase separation to form the porous sorptive polymer on the coated sheet capable of adsorbing analytes. In an embodiment, further curing does not lead to expansion of the polymer network.

In an embodiment, the curing of the prepolymer composition layer forms a porous sorptive polymer coated sheet comprising a porous sorptive polymer coating layer on the solid support sheet. Therefore, in an embodiment, the porous sorptive polymer coated sheet comprises a porous sorptive polymer coating layer on the solid support sheet. In an embodiment, the porous sorptive polymer coated sheet is a uniform porous sorptive polymer coated sheet comprising a uniform porous sorptive polymer coating layer on the support sheet.

In the context of the porous sorptive polymer coated sheet and/or a porous sorptive polymer coating layer, the term “uniform” refers to a porous sorptive polymer coated sheet and/or a porous sorptive polymer coating layer of a thickness that varies by less than 5% over the support sheet surface.

In an embodiment, the depositing and curing step are not repeated after formation of the porous sorptive polymer coated sheet. Therefore, in an embodiment, the porous sorptive polymer coated sheet is prepared using only one depositing and curing sequence.

In an embodiment, the thickness of the porous sorptive polymer coating layer is determined, for example, by the thickness of the prepolymer composition layer. In an embodiment, increasing the thickness of the porous sorptive polymer coating layer increases the capacity of the porous sorptive polymer for exhaustive extraction.

In an embodiment, the porous sorptive polymer coating layer has a thickness of about 2 μm to about 100 μm, about 3 μm to about 100 μm, about 4 μm to about 100 μm, about 5 μm to about 100 μm, about 6 μm to about 100 μm, about 7 μm to about 100 μm, about 8 μm to about 100 μm, about 9 μm to about 100 μm, about 10 μm to about 100 μm, about 10 μm to about 90 μm, about 10 μm to about 80 μm, 10 μm to about 70 μm, about 10 μm to about 60 μm, about 20 μm to about 60 μm, about 30 μm to about 60 μm, about 40 μm to about 60 μm, of about 40 μm to about 40 μm, of about 40 μm to about 45 μm, about 50 μm to about 60 μm, about 10 μm to about 50 μm, about 10 μm to about 40 μm, about 10 μm to about 30 μm, about 10 μm to about 25 μm, about 15 μm to about 25 μm, or about 18 μm to about 25 μm. In an embodiment, the porous sorptive polymer coating layer has a thickness of about 2 μm or greater, about 3 μm or greater, about 4 μm or greater, about 5 μm or greater, of about 6 μm or greater, of about 7 μm or greater, of about 8 μm or greater, of about 9 μm or greater, of about 10 μm or greater, about 20 μm or greater, about 25 μm or greater, about 30 μm or greater, about 40 μm or greater, about 50 μm or greater, about 60 μm or greater, about 70 μm or greater, about 80 μm or greater, or about 90 μm or greater. In an embodiment, the porous sorptive polymer coating layer has a thickness of about 2 μm to about 15 μm, about 2 μm to about 12 μm, about 2 μm to about 10 μm, about 3 μm to about 10 μm, about 4 μm to about 10 μm, about 5 μm to about 10 μm, about 6 μm to about 10 μm, about 7 μm to about 10 μm, about 8 μm to about 10 μm, about 2 μm to about 10 μm, about 2 μm to about 9 μm, about 3 μm to about 9 μm, about 4 μm to about 9 μum, about 5 μm to about 9 μm, about 6 μm to about 9 μm, about 7 μm to about 9 μm, or about 4 μm to about 8 μm, or about 5 μm to about 8 μm. In an embodiment, the polymer coating has a thickness of about 2 μm or greater, about 3 μm or greater, about 5 μm or greater, about 7 μm or greater, about 10 μm or greater. In an embodiment, the porous sorptive polymer coating layer has a thickness of about 20 μm or greater. In an embodiment, the porous sorptive polymer coating layer has a thickness of about 40 μm or greater.

In an embodiment, the support sheet is a stainless steel support sheet and the curing of the prepolymer composition layer forms a porous sorptive polymer coated stainless steel sheet comprising a porous sorptive polymer coating layer on the stainless steel support sheet.

In an embodiment, the porous sorptive polymer coating layer on the on the porous sorptive polymer coated stainless steel support sheet has a thickness of about 10 μm to about 100 μm, about 10 μm to about 90 μm, about 10 μm to about 80 μm, 10 μm to about 70 μm, about 10 μm to about 60 μm, about 20 μm to about 60 μm, about 30 μm to about 60 μm, about 40 μm to about 60 μm, about 50 μm to about 60 μm, about 10 μm to about 50 μm, about 10 μm to about 40 μm, about 10 μm to about 30 μm, about 10 μm to about 25 μm, about 15 μm to about 25 μm, or about 18 μm to about 25 μm. In an embodiment, the porous sorptive polymer coating layer on the on the porous sorptive polymer coated stainless steel support sheet has a thickness of about 10 μm to about 25 μm, about 15 μm to about 25 μm or about 18 μm to about 25, and prepared from a prepolymer composition comprising 4-VP, EGDMA, DMPA and 1-octanol. In an embodiment, the sorptive polymer coating layer has a thickness of about 10 μm to about 25 μm, about 15 μm to about 25 μm or about 18 μm to about 25, and prepared from a prepolymer composition of Formula I.

In an embodiment, the porous sorptive polymer coating layer on the porous sorptive polymer coated stainless steel support sheet has a thickness of about 18 μm to about 25 μm. In an embodiment, the porous sorptive polymer coating layer has a thickness of about 40 μm to about 45 μm or of about 40 μm to about 50 μm. In an embodiment, the porous sorptive polymer coating layer on the porous sorptive polymer coated stainless steel support sheet has a thickness of about 40 μm of about 45 μm, and prepared from a prepolymer composition comprising MAA, EGDMA, DMPA and 1-octanol. In an embodiment, the porous sorptive polymer coating layer has a thickness of about 40 μm of about 45 μm, and prepared from a prepolymer composition of Formula II. In an embodiment, the polymer coating has a thickness of about 41 μm.

In an embodiment, the porous sorptive polymer coated sheet has a thickness of about 250 μm to about 1000 μm, about 400 μm to about 1000 μm, about 500 μm to about 1000 μm, about 600 μm to 900 μm , about 700 μm to about 850 μm or about 750 μm to about 820 μm. In an embodiment, the support sheet is a stainless steel support sheet and has a thickness of about 700 μm to about 850 μm, about 750 μm to about 820 μm, about 780 μm to about 810 μm or about 800 μm.

In an embodiment, the solid support sheet is a fiberglass mesh support sheet and the curing of the prepolymer composition layer forms a porous sorptive polymer coated fiberglass mesh sheet comprising a porous sorptive polymer coating layer on the fiberglass mesh support sheet.

In an embodiment, the fiberglass mesh sheet is comprised of individual fibers. Accordingly, the porous sorptive polymer coated fiberglass mesh sheet comprises fibers coated with porous sorptive polymer coating layer. In an embodiment, the porous sorptive polymer coating layer on the on the porous sorptive polymer coated fiberglass mesh sheet has a thickness that is less than the diameter of the fibers of the fiberglass sheet. In an embodiment, the porous sorptive polymer coating layer on the on the porous sorptive polymer coated fiberglass mesh sheet has a thickness that is greater than the diameter of the fibers of the fiberglass sheet. In an embodiment, the thickness of the porous sorptive polymer coating layer is greater than the diameter of the fibers of the fiberglass sheet and increases the capacity of the porous sorptive polymer for exhaustive extraction. In an embodiment, the porous sorptive polymer coating layer on the on the porous sorptive polymer coated fiberglass mesh sheet has a thickness of about 1 μm or less, about 2 μm or less, about 3 μm or less, about 4 μm or less, about 5 μm or less, of about 6 μm or less, of about 7 μm or less, of about 8 μm or less, of about 9 μm or less, of about 10 μm or less, about 12 μm or less, or about 15 μm or less. In an embodiment, the porous sorptive polymer coating layer on the on the porous sorptive polymer coated fiberglass mesh sheet has a thickness of about 0.5 μm to about 15 μm, about 1 μm to about 15 μm, about 1 μm to about 12 μm, about 1 μm to about 10 μm, about 2 μm to about 10 μm, about 3 μm to about 10 μm, about 4 μm to about 10 μm, about 5 μm to about 10 μm, about 6 μm to about 10 μm, about 7 μm to about 10 μm, about 8 μm to about 10 μm, about 1 μm to about 10 μm, about 1 μm to about 8 μm, about 1 μm to about 5 μm, about 1 μm to about 3 μm, about 2 μm to about 10 μm, about 3 μm to about 9 μm, about 4 μm to about 9 μm, about 5 μm to about 9 μm, about 6 μm to about 9 μm, about 7 μm to about 9 μm, or about 4 μm to about 8 μm or about 5 μm to about 8 μm.

In an embodiment, the porous sorptive polymer coating layer on the porous sorptive polymer coated fiberglass mesh sheet has a thickness of about 5 μm to about 9 μm, about 6 μm to about 9 μm, about 7 μm to about 9 μm, or about 4 μm to about 8 μm or about 5 μm to about 8 μm, and is prepared from a prepolymer composition comprising MAA, EGDMA, DMPA and 1-octanol. In an embodiment, the porous sorptive polymer coating layer on the porous sorptive polymer coated fiberglass mesh sheet has a thickness of about 5 μm to about 9 μm, about 6 μm to about 9 μm, about 7 μm to about 9 μm, or about 4 μm to about 8 μm or about 5 μm to about 8 μm, and is prepared from a prepolymer composition comprising MAA, EGDMA, DMPA, 1-octanol and a template molecule. In an embodiment, the porous sorptive polymer coating layer on the porous sorptive polymer coated fiberglass mesh sheet has a thickness of about 5 μm to about 9 μm, about 6 μm to about 9 μm, about 7 μm to about 9 μm, or about 4 μm to about 8 μm or about 5 μm to about 8 μm and is prepared using the prepolymer composition of Formula III comprising a template molecule, for example, 2-{[diethoxy(sulfanylidene)-λ-phosphanyl]amino}acetic acid:

In an embodiment, the porous sorptive polymer of the porous sorptive polymer coating layer is chosen based on the intended target molecules and/or analytes and the intended desorption process. It would be appreciated by a person skilled in the art, that the porous sorptive polymer of the porous sorptive polymer coating layer sorbs analytes for extraction and removal from a sample matrix. Accordingly, the pore sizes of the porous sorptive polymer should provide sufficient surface area to sorb sufficient analyte to be detectable.

In an embodiment, the porous sorptive polymer of the porous sorptive polymer coating layer comprises particles having a particle size of from about from about 1 nm to about 1000 nm, about 10 nm to about 900 nm, about 50 nm to about 800 nm, about 50 nm to about 700 nm or about 100 nm to about 650 nm. In an embodiment, the porous sorptive polymer coating layer comprises a molecularly imprinted polymer (MIP) comprising particles having a particle size of about 50 nm to about 250 nm, about 50 nm to about 200 nm or about 100 nm to about 150 nm. In an embodiment, the porous sorptive polymer coating layer comprises a MIP comprising particles having a particle size of about 150 nm. In an embodiment, the porous sorptive polymer coating layer comprises a non-molecularly imprinted polymer (NIP) comprising particles having a particle size of about 100 nm to about 800 nm, about 150 nm to about 750 nm, about 200 nm to about 700 nm, about 225 nm to about 650 nm, about 250 nm to about 600 nm, about 300 nm to about 500 nm, or about 350 nm to about 450 nm. In an embodiment, the porous sorptive polymer coating layer comprises a non-molecularly imprinted polymer (NIP) comprising particles having a particle size of about 250 nm to about 600 nm. In an embodiment, the porous sorptive polymer is a non-molecularly imprinted polymer (NIP) comprising particles having a particle size of about 250 nm to about 600 nm. In an embodiment, the porous sorptive polymer is a non-molecularly imprinted polymer (NIP) comprising particles having a particle size of about 300 nm to about 500 nm, about 350 nm to about 450 nm or about 400 nm.

In an embodiment, the process further comprises removing non-adhered material from the porous sorptive polymer coated sheet. In an embodiment, the non-adhered material includes unreacted starting material, byproducts, and, in the case of MIPs, the template molecule. In an embodiment, the non-adhered material is removed by washing, heating or evacuated under pressure. In an embodiment, the non-adhered material can be removed by washing with one or more suitable solvents. In an embodiment, the suitable solvent is an aqueous solvent, organic acid or an organic solvent or a mixture thereof. In an embodiment, the solvent is water, methanol or ethanol or a mixture thereof. In an embodiment, the suitable solvent is water or methanol and mixtures thereof. In an embodiment, the solvent is an organic acid. In an embodiment, the organic acid is acetic acid. In an embodiment, the acetic acid is 10% (v/v) acetic acid. In an embodiment, the solvent is a mixture of an organic acid and organic solvent. In an embodiment, the solvent is a mixture of acetic acid and methanol.

In an embodiment, the cutting is by any suitable means of cutting the porous sorptive polymer coated sheet to provide a plurality of SPME devices known in the art. In an embodiment, more than one porous sorptive polymer coated sheet, for example, a stack of polymer coated sheets, is cut at the same time. In an embodiment, the cutting is performed with a suitable cutting machine. In an embodiment, the cutting machine is a die cutting machine, waterjet cutter, plasma cutter, or laser cutter. In an embodiment, the cutting machine is a die cutting machine. In an embodiment, the die cutting machine is a manual die cutting machine or electronic die cutting machine. In an embodiment, the electronic die cutting machine is commercially available such as Silhouette Cameo®, Silhouette Portrait®, or Cricut Maker® or Cricut Explorer®. In an embodiment, the die cutting machine is used to cut fiberglass mesh support sheets or carbon fiber support sheets. In an embodiment, the cutting machine is a waterjet cutter. In an embodiment, the waterjet cutter is used to cut metallic, glass and plastic support sheets.

In an embodiment, the method of the application permits a porous sorptive polymer coated sheet with a large surface area to be initially formed, and subsequently cut into a plurality of porous sorptive solid phase microextraction devices that are compositionally equal.

In an embodiment, the number of formed porous sorptive polymer solid phase microextraction devices is proportional to the size of the porous sorptive polymer coated sheet. In an exemplary embodiment, when the solid support sheet is about 20 cm to about 40 cm in width or about 20 cm to about 40 cm in length or about 20 cm to about 30 cm in width by about 20 cm to about 30 cm in length, the porous sorptive polymer coated sheet is cut into, but not limited to, 2 or more, about 3 or more, about 4 two or more, about 5 or more, about 10 or more, about 15 or more, about 20 or more, about 25 or more, about 30 or more, about 40 or more, about 50 or more, about 75 or more, about 100 or more, about 200 or more, about 300 or more, about 400 or more, about 500 or more, about 600 or more about 700 or more, about 800 or more about 900 or more, about 1000 or more about 1200 or more porous sorptive solid phase microextraction devices. In an embodiment, when the solid support sheet is about 20 cm to about 40 cm in width or about 20 cm to about 40 cm in length or about 20 cm to about 30 cm in width by about 20 cm to about 30 cm in length, the porous sorptive polymer coated sheet is cut into 2 to about 1200, about 5 to about 1200, about 10 to about 1000, about 20 to about 1000, about 30 to about 900, about 30 to about 900, about 50 to about 800 sorptive solid phase microextraction devices.

In an embodiment, the porous sorptive polymer coated sheet is cut into a plurality of porous sorptive that are of any desired shape or size. In an embodiment, the porous sorptive polymer coated sheet is cut into a plurality of porous sorptive solid phase microextraction devices that are the same shape and size. In an embodiment, the porous sorptive polymer coated sheet is cut into a plurality of porous sorptive solid phase microextraction devices that are of different shapes and sizes. In an embodiment, the porous sorptive polymer coated sheet is cut to form a plurality of porous sorptive solid phase microextraction devices having circular (disk), triangular, square, rectangular, and/or pentagonal shapes as known in the art. In an embodiment, the porous sorptive polymer coated sheet is cut form a plurality of porous sorptive solid phase microextraction devices that are irregularly shaped. In an embodiment, the porous sorptive polymer coated sheet is cut to form a plurality of porous sorptive solid phase microextraction devices that are substantially equally shaped. In an embodiment, the porous sorptive polymer coated sheet is cut to form a plurality of porous sorptive solid phase microextraction devices that are shaped to be compatible with a vessel for holding a sample matrix comprising one or more analytes to be extracted. In an embodiment, the vessel is a vial or a centrifuge tube such as an Eppendorf® tube. In an embodiment, the porous sorptive polymer coated sheet is cut into a plurality of individual porous sorptive solid phase microextraction devices that are compatible with spot sampling. In an embodiment, the polymer coated sheet is cut into a plurality of individual porous sorptive solid phase microextraction devices that are compatible with an active and/or passive sampling procedure.

In an exemplary embodiment, the porous sorptive polymer coated sheet is cut to form a plurality of porous sorptive solid phase microextraction devices that are generally rectangularly shaped, referred to herein as strips. Accordingly, in an embodiment, the porous sorptive solid phase microextraction devices are porous sorptive solid phase microextraction strips. In an embodiment, the porous sorptive polymer coated sheet is cut to form a plurality of equally sized porous sorptive SPME strips. In an embodiment, the porous sorptive SPME strips are prepared using a fiberglass mesh support sheet and are porous sorptive SPME fiberglass mesh strips. In an embodiment, the porous sorptive SPME strips are prepared using a stainless steel support sheet and are porous sorptive SPME stainless steel (or metallic) strips, referred to herein as blades.

In an embodiment, the exemplary porous sorptive SPME strips of the application generally have a length greater than its width. In an embodiment, the porous sorptive SPME strips have a length of about 5 mm to about 150 mm, about 5 mm to about 125 mm, about 5 mm to about 100 mm, about 10 mm to about 100 mm, about 20 mm to about 100 mm, about 30 mm to about 100 mm, about 50 mm to about 100 mm, about 50 mm to about 80 mm; or about 5 mm, about 10 mm, about 20 mm, about 30 mm, about 40 mm, about 50 mm, about 60 mm, about 70 mm, about 80 mm, about 90 mm, or about 100 mm. In an embodiment, the polymer coated strips have a length of about 30 mm to about 100 mm, about 50 mm to about 100 mm or about 50 mm to about 80 mm; or about 70 mm, about 80 mm, about 90 mm, or about 100 mm. In an embodiment, the porous sorptive SPME strips are porous sorptive SPME fiberglass mesh strips. In an embodiment, the porous sorptive SPME strips are porous sorptive SPME stainless steel (or metallic) strips (e.g., blades).

In an embodiment, the porous sorptive SPME strips have a width of about 1 mm to about 40 mm, about 1 mm to about 30 mm, about 1 mm to about 25 mm, about 2 mm to about 25 mm, about 3 mm to about 25 mm, about 4 mm to about 25 mm, about 5 mm to about 20 mm, about 5 mm to about 30 mm, about 10 mm to about 30 mm, or about 15 mm to about 30 mm. In an embodiment, the porous sorptive SPME strips have a width of about 1 to about 10 mm, about 2 mm to about 10 mm, about 3 mm to about 10 mm, about 3 mm to about 7 mm, or about 4 mm to about 6 mm. In an embodiment, the porous sorptive SPME strips have a width of about 5 mm to about 25 mm, about 10 mm to about 25 mm, about 15 mm to about 25 mm, about 17 mm to about 23 mm or about 18 mm to about 22 mm. In an embodiment, the porous sorptive SPME strips have a width of about 1 mm, about 2 mm, about 3 mm, about 4 mm, about 5 mm, about 6 mm, about 7 mm, about 8 mm, about 9 mm, about 10 mm, about 11 mm, about 12 mm, about 13 mm, about 14 mm, about 15 mm, about 16 mm, about 17 mm, about 18 mm, about 19 mm, about 20 mm, or about 21 mm. In an embodiment, the porous sorptive SPME strips have a width of about 4 mm, about 5 mm, about 6 mm, or about 7 mm. In an embodiment, the porous sorptive SPME strips have a width of about 19 mm, about 20 mm, or about 21 mm.

In an embodiment, the polymer coated strips are porous sorptive SPME stainless steel (or metallic) strips (e.g., blades) and have a length of about 5 mm to about 30 mm, about 10 mm to about 30 mm, about 15 mm to about 30 mm, or about 5 mm, about 15 mm, about 20 mm, about 25 mm or about 30 mm. In an embodiment, the polymer coated strips are porous sorptive SPME stainless steel (or metallic) strips (e.g., blades) and have a length of about 10 mm to about 30 mm. In an embodiment, the porous sorptive SPME strips are porous sorptive SPME metallic strips (e.g., blades) and have a width of about 3 mm to about 7 mm, or about 4 mm to about 6 mm, or about 5 mm.

In an embodiment, the porous sorptive SPME strips are porous sorptive SPME fiberglass mesh strips and have a length of about 20 mm to about 100 mm, about 30 mm to about 90 mm, about 40 mm to about 90 mm, about 60 mm to about 90 mm, about 70 mm to about 90 mm, or about 20 mm, about 30 mm, about 40 mm, about 50 mm, about 60 mm, about 70 mm, or about 80 mm. In an embodiment, the porous sorptive SPME strips are porous sorptive SPME fiberglass mesh strips and have a length of about 60 mm to about 90 mm, about 70 mm to about 90 mm, or about 60 mm or about 80 mm. In an embodiment, the porous sorptive SPME strips are porous sorptive SPME fiberglass mesh strips and have a width of about 5 mm to about 30 mm, about 10 mm to about 25 mm, about 15 mm to about 25 mm, about 17 mm to about 23 mm or about 18 mm to about 22 mm, or about 20 mm.

The process of the application permits a large area porous sorptive polymer coated sheet to be initially formed, and subsequently cut into a plurality of porous sorptive solid phase microextraction devices that are compositionally equal. Accordingly, it would be appreciated by a person skilled in the art that the process of the application allows for batch production of porous sorptive polymer coated SPME devices. Therefore, in an embodiment, the process of the application is a batch production process. It would be further appreciated by a person skilled in the art that the process of the application is also scalable, for example, by increasing or decreasing the size of the support sheet. As a plurality of porous sorptive polymer coated SPME devices of same or different sizes resulting from the same depositing and curing cycle are prepared, it would be further appreciated by a person skilled in the art that the process of the application provides plurality of porous sorptive polymer coated device with substantially reduced or insignificant inter- and intra-device variability. Batch processing further provides sorptive SPME devices which are reliable and inexpensive in a cost-effective manner.

In an embodiment, a porous sorptive polymer mesh coated sheet having of length of about 20 cm to about 30 cm and a width of about 20 cm to about 30 cm is formed in less than about one minute, less than about 45 seconds, less than about 30 seconds, less than about 20 seconds, about 30 seconds to about 1 minute, about 45 seconds to about 1 minute. In an embodiment, a porous sorptive polymer coated mesh sheet having of length of about 30 cm and a width of about 30 cm is formed in less than 30 seconds. Therefore, the process of the application is efficient.

In an embodiment, one or more of the plurality of porous sorptive SPME devices comprises a porous sorptive polymer coating layer on a solid support. In an embodiment, one or more of the plurality of porous sorptive SPME devices comprises a uniform porous sorptive polymer coating layer on a solid support.

In an embodiment, one or more of the plurality of porous sorptive SPME devices are used as is (e.g., fully coated) or a portion of the porous sorptive polymer coating layer on the one or more of the plurality of porous sorptive SPME devices is removed from one or more of the plurality of porous sorptive SPME devices or from the porous sorptive polymer coated sheet prior to cutting. Accordingly, in an embodiment, the process further comprises removing a portion of the porous sorptive polymer coating layer from the porous sorptive polymer coated sheet or from one or more of the plurality of porous sorptive SPME devices to obtain a porous sorptive polymer coated portion and a non-coated porous sorptive polymer portion (i.e., exposed solid support sheet of the porous sorptive polymer coated sheet or the one or more of the plurality of porous sorptive SPME devices. In an embodiment, the porous sorptive polymer coating layer is removed from a portion of the porous sorptive polymer coated sheet or from the one or more of the plurality porous sorptive SPME device manually. In an embodiment, the porous sorptive polymer coating layer is removed from a portion of the porous sorptive polymer coated sheet or from a portion of the one or more of the plurality of porous sorptive SPME devices using a suitable solvent capable of degrading the porous sorptive polymer coating. In an embodiment, a portion of the porous sorptive polymer coated sheet or a portion of one or more of the plurality porous sorptive SPME devices is dipped into suitable solvent capable of degrading the porous sorptive polymer coating to a desired porous sorptive polymer coated portion.

In an exemplary embodiment, when the sorptive SPME devices are porous sorptive SPME strips and a portion of the porous sorptive polymer coating is removed, then the length and the width of the porous sorptive polymer coated portion of the porous sorptive SPME strip is less than the length and/or the width of the porous sorptive SPME strip. In an embodiment, the length and/or width of the porous sorptive polymer coated portion of the porous sorptive SPME strip is less than the length and/or width of the porous sorptive SPME strip. In an embodiment, the length of the porous sorptive polymer coated portion on the porous sorptive SPME strip is less than the length of the porous sorptive SPME strip. In an embodiment, the width of the porous sorptive polymer coated portion on the porous sorptive SPME strip is less than the width of the porous sorptive SPME strip. In an embodiment, the length and width of the porous sorptive polymer coated portion on the porous sorptive SPME strip is less than the length and the width of the sorptive SPME strip.

In an embodiment, a portion of the surface of the solid support sheet is masked by a masked material before the step of depositing the prepolymer composition to prevent a portion of the surface of the solid support from being coated with the prepolymer composition. In an embodiment, after the step of depositing or the step curing, the masking material is removed to produce a non-coated portion of the support sheet and a coated portion of the solid support sheet. Therefore, in an embodiment, prior to the step of depositing the prepolymer composition, the method further comprises masking a portion of the solid support sheet with a masking material to form a masked solid support sheet, and depositing a prepolymer composition on an entire surface of the masked solid support sheet to form a uniform prepolymer composition layer on the masked solid support sheet. In an embodiment, the method further comprises removing the masking material from the masked solid support sheet prior to or after the step of curing to produce a prepolymer composition coated portion or a porous sorptive polymer coated portion and a non-prepolymer composition coated portion or non-porous sorptive polymer coated portion of solid support sheet or porous sorptive polymer coated sheet, respectively. In an embodiment, the masking material is any inert material that can be used to mask a portion of the surface of the solid support sheet. In an embodiment, the masking material is a sheet of material such as paper or another support sheet. In an embodiment, the masking material is a lubricant such as an oil, a fat or a grease.

In an embodiment, the porous sorptive polymer coated sheet is cut to form a plurality of porous sorptive SPME devices having desired shapes, or one or more of the plurality of porous sorptive SPME devices is further shaped after the step of cutting. In an exemplary embodiment, the porous sorptive polymer coated sheet is cut to form generally rectangular porous sorptive polymer coated strips. In an embodiment, the porous sorptive SPME strips are porous sorptive SPME metallic strips wherein the porous sorptive SPME metallic strips comprise a porous sorptive polymer coating layer on a metallic solid support and the process further comprises removing a portion of the porous sorptive polymer coating layer from one or more of the plurality of porous sorptive SPME metallic strips. In an embodiment, the porous sorptive polymer coated sheet is cut to form generally rectangular porous sorptive SPME strips comprising a triangular tip on one end. In an embodiment, the porous sorptive polymer coated sheet is cut into generally rectangular strips and the rectangular strips are further shaped to comprise a triangular tip on one end. In an embodiment, the porous sorptive SPME strips are porous sorptive SPME metallic strips comprising a triangular tip on one end. In an embodiment, a portion of the porous sorptive polymer coating layer is removed from an end opposite to end comprising the triangle tip end of one or more of the plurality of porous sorptive SPME metallic strips (e.g., blades) comprising a triangular tip. In an embodiment, all of the porous sorptive polymer coating layer is removed from one or more of the plurality of porous sorptive SPME metallic strip comprising a triangular tip on one end except for the area of the triangular tip to produce tip coated porous sorptive SPME metallic strip (e.g. blades).

In an embodiment, the porous sorptive SPME devices are shaped for use directly with an analytical instrument. In an embodiment, the analytic instrument is a gas chromatography flame ionization detector (GC-FID), a gas chromatograph (GC), a high performance liquid chromatography (HPLC) system, an ultra-performance liquid chromatography (UPLC) system, a capillary electrophoresis instrument, a mass spectrometer (MS), an ion-mobility spectrometry-mass spectrometer (IMS-MS), a gas chromatography-mass spectrometer (GC-MS), a liquid chromatography-mass spectrometer (LC-MS), a gas chromatography-tandem mass spectrometer (GC-MS/MS) or a liquid chromatography-tandem mass spectrometer (LC-MS/MS). In an embodiment, the MS is a miniature MS which can be a portable or handheld MS device.

In an exemplary embodiment, the present application includes a process of preparing a plurality of porous sorptive solid phase microextraction (SPME) devices comprising:
depositing a prepolymer composition comprising a one or more monomers or a mixture of monomers, one or more cross-linking agents, one or more polymer initiators and one or more porogens, on a surface of a solid support sheet to form a uniform prepolymer composition layer on the solid support sheet;
ultraviolet (UV) curing the prepolymer composition layer to form a porous sorptive polymer coated sheet comprising a porous sorptive polymer coating layer on the solid support sheet; and
cutting the porous sorptive polymer coated sheet to form the plurality of porous sorptive SPME devices.

In an embodiment, the depositing of the prepolymer composition is on an entire surface of a solid support sheet to form a uniform prepolymer composition layer on the solid support sheet. In an embodiment, the depositing of the prepolymer composition is on substantially an entire surface of a solid support sheet to form a substantially uniform prepolymer composition layer on substantially the entire surface of the solid support sheet. In an embodiment, the depositing is by spraying. In an embodiment, the spraying is by spray coating. The Applicant has developed a plurality of porous sorptive SPME devices comprising a support sheet coated with a porous sorptive polymer created by polymerization of a prepolymer composition on the support sheet using the high throughput process described above.

Accordingly, the present application also includes a porous sorptive SPME device (optionally a plurality of porous sorptive SPME devices) produced by a process described above.

The present application further includes a porous sorptive solid phase microextraction (SPME) device comprising:
a porous sorptive polymer coating layer on a solid support,
wherein the porous sorptive microextraction device is one of a plurality of porous sorptive SPME devices formed by cutting a porous sorptive polymer coated sheet.

In an embodiment, the porous sorptive polymer coating layer covers only a portion of the solid support. Therefore, in an embodiment, the present application further includes a porous sorptive solid phase microextraction (SPME) device comprising:
a porous sorptive polymer coating layer covering at least a portion of a solid support,
wherein the porous sorptive microextraction device is one of a plurality of porous sorptive SPME devices formed by cutting a porous sorptive polymer coated sheet.

In an embodiment, the porous sorptive polymer coating layer is a uniform porous sorptive polymer coating layer.

In an embodiment, the porous sorptive polymer coated sheet comprises the porous sorptive polymer coating layer on a surface of a solid support sheet. In an embodiment, the porous sorptive polymer coated sheet comprises the porous sorptive polymer coating layer on an entire surface of a solid support sheet. In an embodiment, the porous sorptive polymer coated sheet comprises the porous sorptive polymer coating layer on substantially an entire surface of a solid support sheet.

In an embodiment, the porous sorptive polymer coated sheet is prepared by the processes described above. Therefore, in an embodiment, the porous sorptive polymer coated sheet is prepared by a process comprising:
depositing a prepolymer composition on a surface of a solid support sheet to form a uniform prepolymer composition layer on the surface of the solid support sheet;
curing the prepolymer composition layer to form the porous sorptive polymer coated sheet; and
optionally, removing non-adhered material from the porous sorptive polymer coated sheet.

In an embodiment, the porous sorptive polymer coating layer is a uniform porous sorptive coating layer. Therefore, in an embodiment, the porous sorptive SPME device comprises a uniform porous sorptive polymer coating layer on the solid support or covering at least a portion of a solid support.

In an embodiment, the porous sorptive SPME device is configured for use directly with an analytical instrument. In an embodiment, the porous sorptive SPME device is a porous sorptive SPME metallic strip (e.g., blade). In an embodiment, the porous sorptive SPME device is a porous sorptive SPME metallic strip or blade with a triangular tip. In an embodiment, the SPME device is a porous sorptive SPME fiberglass mesh strip. In an embodiment, the porous sorptive SPME device is a tip coated porous sorptive SPME metallic strip (e.g., tip coated blade).

### III. Uses of the Porous Sorptive Solid Phase Microextraction (SPME) Device

The Applicant has shown that the porous sorptive solid phase microextraction (SPME) devices of the application can be used in the analysis of analytes from sample matrices. In particular, the porous sorptive solid phase microextraction (SPME) devices have been used, for example, in the extraction of organophosphorus pesticide (OPPs) from water samples and the extraction of drugs of abuse from bodily fluids such as urine and blood plasma.

Accordingly, the present applications also include a method of extracting one or more analytes from a sample matrix comprising,
providing a porous sorptive solid phase microextraction (SPME) device produced by a process described above comprising a porous sorptive polymer coating layer covering at least a portion of a solid support;
exposing the porous sorptive polymer coating layer to the sample matrix comprising the one or more analytes under conditions for the porous sorptive polymer coating layer to extract the one or more analytes from the sample matrix; and
separating the porous sorptive SPME device from the sample matrix.

In an embodiment, the porous sorptive polymer coating layer is a uniform porous sorptive coating layer. Therefore, in an embodiment, the method comprises exposing a uniform porous sorptive polymer coating layer to the sample matrix comprising the one or more analytes under conditions for the porous sorptive polymer coating layer to extract the one or more analytes from the sample matrix.

In an embodiment, the sample matrix is a liquid, solid or gaseous sample matrix. In an embodiment, the sample matrix is a liquid sample matrix. In an embodiment, the sample matrix is a biological, environmental or food sample matrix. In an embodiment, the liquid sample matrix is a biological, environmental or food liquid sample matrix. In an embodiment, the biological sample matrix is a bodily fluid. In an embodiment, the bodily fluid is urine or blood or components thereof such as blood plasma. In an embodiment, the environmental sample matrix is water. In an embodiment, the water is drinking water, surface water or ground water. In an embodiment, the water is drinking water or surface water.

In an embodiment, the step of exposing the porous sorptive polymer coating layer to the sample matrix comprising the one or more analytes comprises contacting the porous sorptive polymer coating layer with the sample matrix, or placing the porous sorptive polymer coating layer in a headspace suitably close to the sample matrix.

In an embodiment, the step of contacting of the porous sorptive polymer coating layer with the sample matrix comprises partially or completely immersing the porous sorptive SPME device comprising the porous sorptive polymer coating layer in the sample matrix. In an embodiment, the step of contacting the porous sorptive polymer coating layer with the sample matrix comprises applying the sample matrix to the porous sorptive polymer coating layer. In an embodiment, the step of applying the sample matrix to the porous sorptive polymer coating layer comprises spotting the sample matrix onto the porous sorptive polymer coating layer. In an embodiment, the spotting is performed with a pipette or a syringe.

In an embodiment, the conditions for the porous sorptive polymer coating layer to extract the one or more analytes from the sample matrix are any suitable extraction conditions known in the art, including, for example, sorption time, temperature and/or sample concentration, the selection of which would be within the purview of a person skilled in the art.

In an embodiment, the step of exposing the porous sorptive polymer coating layer to the sample matrix comprising the one or more analytes is for length of time to allow for sufficient extraction of the one of more analytes and/or for extraction pre-equilibrium or equilibrium to be achieved. In an embodiment, the step of exposing the porous sorptive polymer coating layer to the to the sample matrix comprising the one or more analytes is for length of time sufficient to allow exhaustive equilibrium to be achieved.

In an embodiment, the rate of extraction is enhanced by agitating the sample matrix and the porous sorptive solid phase microextraction (SPME) device. In an embodiment, the sample matrix and the porous sorptive solid phase microextraction (SPME) are agitated by any suitable agitation method known in the art. In an embodiment, the sample matrix and the porous sorptive solid phase microextraction (SPME) are agitated by shaking by hand, by sonication, by using a magnetic stirrer, by using a shaker such as a liner, orbital or 3D shaker, by using a multi position stirrer or by using an electric mixer such as vortex mixer.

In an embodiment, the step of exposing of the porous sorptive polymer coating layer to the sample matrix comprising the one or more analytes is dependent on the nature of analytes, the coating and the sample volume. In an embodiment, the step of exposing of the porous sorptive polymer coating layer to the sample matrix comprising the one or more analytes is for more than 1 day, more than 2 days or more than 3 days. In an embodiment, the step of exposing of the porous sorptive polymer coating layer to the sample matrix comprising the one or more analytes is for about 1 min to about 320 min, about 1 min to about 280 min, about 1 min to about 250 min, about 1 min to about 220 min, about 1 min to about 200 min, about 1 min to about 175 min, about 1 min to about 120 min, about 5 min to about 30 min; or about 250 minutes, about 200 minutes, about 150 minutes, about 120 minutes, about 90 minutes, about 60 minutes or about 30 minutes. In an embodiment, the step of exposing is for a time sufficient to allow for pre-equilibrium or equilibrium extraction to be achieved.

In an embodiment, the method further comprises optionally preconditioning the porous sorptive polymer coating layer prior to step of exposing the porous sorptive polymer layer to the sample matrix. In an embodiment, the preconditioning is by heating. In an embodiment, the heating is performed in a vacuum oven. In an embodiment, the preconditioning is by wetting the porous sorptive polymer coating layer with a suitable solvent. In an embodiment, the suitable solvent is an aqueous solvent or an organic solvent or a mixture thereof. In an embodiment, the solvent is water, methanol or ethanol or a mixture thereof. In an embodiment, the suitable solvent is water. In an embodiment, the porous sorptive polymer coating layer does not require preconditioning prior to exposing the porous sorptive polymer layer to the sample matrix. In an embodiment, porous sorptive SPME device is a porous sorptive metallic SPME device, including for example, porous sorptive SPME blade or porous sorptive SPME tip coated blade and BLADE and does not require preconditioning prior to exposing the porous sorptive polymer layer to the sample matrix.

In an embodiment, the step of separating is removing the porous sorptive SPME device from the sample matrix.

In an embodiment, the method further comprises optionally washing the porous sorptive polymer coating layer of the porous sorptive SPME device after extracting the one or more analytes. The washing step may remove free or loosely attached sample matrix components. In an embodiment, the washing is performed using one or more suitable solvents. In an embodiment, the suitable solvent is an aqueous solvent or an organic solvent or a mixture thereof. In an embodiment, the solvent is water, methanol or ethanol or a mixture thereof. In an embodiment, the suitable solvent is water.

In an embodiment, the method further comprises optionally drying the porous sorptive polymer coating layer of the porous sorptive SPME device after the extracting or washing. In an embodiment, the drying is by heating, air drying or by using an adsorbent material. In an embodiment, the adsorbent material is a paper adsorbent material. In an embodiment, the adsorbent material is Kimwipes®.

In an embodiment, the one or more analytes is a protein, a peptide or a small molecule. In an embodiment, the small molecule is a contaminant, a drug, a biomarker or metabolite.

In an embodiment, the contaminant is an organophosphorus pesticides (OPP), or a polycyclic aromatic hydrocarbon (PAH), and mixtures thereof.

In an embodiment, the OPP is selected from demeton-S-methyl, ethoprophos, parathion methyl, tolcofos methyl, methidathion, fenamiphos, diazinon, pirimiphos methyl, disulfoton sulfone, azynphos-methyl, malathion, prothiofos, chlorpyrifos, tetrachlorvinphos, profenofos, pyrazophos, ethion, dichlorvos, phosmet, fenitrothion, azamethiphos and terbufos, and mixtures thereof.

In an embodiment, the PAH is selected from naphthalene, anthracene, phenanthrene, phenalene, tetracene, chrysene, triphenylene, pyrene, pentacene, benzo[a]pyrene, corannulene, benzo[ghi]perylene, coronene, ovalene and benzo[c]fluorine or mixtures thereof.

In an embodiment, the drug is mycophenolate. In an embodiment, the drug is a drug of abuse. In an embodiment, the drug of abuse is a tricyclic antidepressant. In an embodiment, the tricyclic antidepressant is selected from amitriptyline, imipramine, clomipramine, desipramine, doxepin, trimipramine and nortriptyline and mixtures thereof.

In an embodiment, the drug of abuse is selected from cocaine, amphetamine, methamphetamine, methylenedioxymethamphetamine (MDMA), flunitrazepam, gamma-hydroxybutyrate, mescaline, psilocybin, ketamine, phencyclidine, dextromethorphan, lysergic acid diethylamide, methadone, CNS depressants, stimulants and opioid pain relievers, and mixtures thereof.

In an embodiment, the CNS depressant is selected from benzodiazepines such as diazepam, clonazepam, alprazolam, or triazolam, non-benzodiazepine compounds such as zolpidem, eszopiclone, or zaleplon and barbiturates, such as mephobarbital, phenobarbital and pentobarbital sodium and mixtures thereof.

In an embodiment, the stimulant is dextroamphetamine or methylphenidate.

In an embodiment, the opioid is codeine, morphine, methadone or fentanyl, oxycodone, hydrocodone, hydromorphone, oxymorphone, meperidine or propoxyphene or mixtures thereof.

In an embodiment, the method further comprises desorbing the one or more analytes from the porous sorptive polymer coating layer.

In an embodiment, the desorption method may be determined by the compatibility of the porous sorptive polymer coating layer with the desorption method. In an embodiment, the desorbing is by thermal-assisted desorption or by solvent based desorption.

In an embodiment, the solvent based desorption comprises contacting the polymer coating layer with a suitable solvent to form an analyte solution. In an embodiment, the suitable solvent is one that would extract the analyte from the polymer coating layer, but does not dissolve or otherwise disrupt the polymer coating layer. In an embodiment, the suitable solvent is an aqueous solvent or an organic solvent or a mixture thereof. In an embodiment, the solvent is water. In an embodiment, the organic solvent is a hydrocarbon, an alcohol, a chlorinated solvent, an ester, an ether, a nitrile or combinations thereof. In an embodiment, the hydrocarbon is an aliphatic, cyclic or aromatic hydrocarbon. In an embodiment, the suitable solvent is methanol.

In an embodiment, the rate of solvent based desorption is enhanced by agitating the solvent and porous sorptive polymer coating. In an embodiment, the agitating is by shaking by hand, by sonication, by using a magnetic stirrer, by using a shaker such as a liner, orbital or 3D shaker, by using a multi position stirrer or by using an electric mixer such as vortex mixer. In an embodiment, the agitating is by using a multi position stirrer. In an embodiment, the agitating is by using a vortex mixer. In an embodiment, the vortex mixer is used at a speed of about 500 rpm to about 2500 rpm, about 500 rpm to about 2000 rpm, about 500 rpm to about 1500 rpm, about 750 rpm to about 1500 rpm, about 800 rpm to about 1500 rpm, about 900 rpm to about 1500 rpm, or about 1000 rpm to about 1500 rpm, or about 800 rpm, 900 rpm, 1000 rpm, 1100 rpm, 1200 rpm, 1300 rpm, 1400 rpm, or 1500 rpm. In an embodiment, the vortex mixer is used at a speed of about 1000 rpm to about 1500 rpm, or about 1000 rpm or about 1500 rpm.

In an embodiment, the desorbing by solvent desorption the one or more analytes are extracted from the polymer coating back into solvent. Therefore, in an embodiment, the desorbing by solvent desorption is for a length of time to allow for sufficient extraction of the one of more analytes and/or for extraction equilibrium. In an embodiment, the desorption is complete desorption. In an embodiment, the desorption is non-complete desorption.

In an embodiment, the desorbing by solvent desorption is for about 1 min to about 260 min, about 1 min to about 175 min, about 1 min to about 120 min, about 5 min to about 30 min, or about 30 minutes. In an embodiment, the desorbing is for a time sufficient to allow for exhaustive extraction. In an embodiment, the desorbing is for a time sufficient to allow for equilibrium extraction to be achieved. In an embodiment, the desorbing is repeated until complete desorption is achieved. In an embodiment, the desorbing is repeated two or three times. In an embodiment, the desorbing is repeated two times. In an embodiment, the desorbing is repeated three times.

In an embodiment, the method further comprises optionally separating the desorbed analytes prior to detection. In an embodiment, the separating is by chromatography. In an embodiment, the chromatography is gas chromatography or liquid chromatography.

In an embodiment, the further comprises optionally purifying the analyte solution prior to detection. In an embodiment, the analyte solution is centrifuged or filtered, for example, filtered through filter paper or sintered glass.

In an embodiment, the thermal-assisted desorption may comprise exposing the polymer coating to a temperature of up to about 250° C., or up to about 300° C.

In an embodiment, the method further comprises detecting the one or more analytes.

In an embodiment, the detecting is with an analytical instrument suitable for determination of the one or more analytes. In an embodiment, the analytic instrument is a gas chromatography flame ionization detector (GC-FID), a gas chromatograph (GC), a high performance liquid chromatography (HPLC) system, an ultra-performance liquid chromatography (UPLC) system, a capillary electrophoresis instrument, a mass spectrometer (MS), an ion-mobility spectrometry-mass spectrometer (IMS-MS), a gas chromatography-mass spectrometer (GC-MS), a liquid chromatography-mass spectrometer (LC-MS), a gas chromatography-tandem mass spectrometer (GC-MS/MS) or a liquid chromatography-tandem mass spectrometer (LC-MS/MS). In an embodiment, the MS is a miniature MS which can be a portable or handheld MS device.

In an embodiment, the detecting is by thermal desorption-gas chromatography-mass spectrometry (TD-GC-MS).

In an embodiment, the method further comprises injecting the analyte solution into an analytical instrument.

In an embodiment, the method comprises desorbing the one or more extracted analytes from the porous sorptive polymer coating layer and directly transferring the one or more extracted analytes to an analytical instrument. In an embodiment, the desorption is by electrothermal vaporization, matrix-assisted laser desorption/ionization (MALDI), desorption electrospray ionization (DESI), or the DESI is in tandem with MS, desorption atmospheric pressure photoionization (DAPPI), and the DAPPI is in tandem with MS. In an embodiment, the desorption and detection is by desorption electrospray ionization (DESI). In an embodiment, the desorption and detection is by desorption electrospray ionization (DESI) in tandem with MS.

In an embodiment, the porous sorptive SPME device is a porous sorptive SPME fiberglass mesh strip. In an embodiment, porous sorptive SPME device is a porous sorptive SPME tip coated blade.

In an embodiment, the method does not require desorbing the one or more analytes from the porous sorptive polymer coating layer of the porous sorptive SPME device prior to the step of detecting the one or more analytes.

In an embodiment, the porous sorptive SPME device is configured for use directly with an analytical instrument. In an embodiment, the porous sorptive SPME device is configured for use directly with an analytical instrument without desorbing the one or more analytes from the porous sorptive polymer coating layer of the porous sorptive SPME device. In an embodiment, the porous sorptive SPME device is a porous sorptive SPME metallic strip (e.g., blade). In an embodiment, the porous sorptive SPME device is a porous sorptive SPME metallic strip with a triangular tip (e.g., tip coated blade). In an embodiment, the porous sorptive SPME device is a porous sorptive SPME metallic strip (e.g., blade) or porous sorptive SPME metallic strip with a triangular tip (e.g., tip coated blade) and is configured for use directly with an analytical instrument without desorbing the one or more analytes from the porous sorptive polymer coating layer of the porous sorptive SPME device.

It would be appreciated by a person skilled in the art, that by using a plurality of porous sorptive SPME devices of the application, along with various shakers or mixers as described above, if necessary, the method of extracting one or more analytes of the application may be implemented simultaneously thereby providing a semi-automated/automated extraction, or extraction and optionally desorption process. Using porous sorptive SPME devices of the application configured for use directly with an analytical instrument such as, for example, an LC/MS-MS or miniature MS, further allows for the portability of the method allowing on-site sampling including in vivo sampling and detecting. The high throughput method of the application thereby facilitates the process of monitoring of analytes, for example, drugs of abuse as well as environmental pollutants.

The following non-limiting examples are illustrative of the present application:

### EXAMPLES

### Example 1: Exemplary Porous Sorptive Solid Phase Microextraction (SPME) Devices of the Application and Preparation and Uses Thereof

### A. Preparation of Exemplary Porous Sorptive Solid Phase Microextraction Devices and Uses Thereof

### a) Chemicals and Reagents

Organophosphorus pesticides (OPPs) standards including malathion, parathion methyl, fenamiphos, diazinon and chlorpyrifos were purchased from Sigma Aldrich (Oakville, ON, Canada). Other standards solutions of other OPPs (i.e., dichlorvos, mevinphos, dimethoate, demeton-S-methyl, ethoprophos, paraoxon methyl, parathion methyl, tolclofos methyl, methidathion, fenamiphos, diazinon, pirimiphos methyl, disulfoton sulfone, azinphos methyl, malathion, prothiofos, chlorpyrifos, tetrachlorvinphos, profenofos, pyrazophos and ethion were purchased from Restek (Bellefonte, PA, USA). Drug standard stock solutions including cocaine, methamphetamine, 3,4-Methylenedioxymethamphetamine (MDMA), methadone, methadone-d3 were purchased from Cerilliant (Round Rock, TX, USA). Biological samples including synthetic urine, human urine and human plasma were purchased from BioIVT (Westbury, NY, USA).

Reagents used for preparation of the polymer sorbent 4-vinyl pyridine (4-VP, 95%), methacrylic acid (MAA, 95%) functional monomers, ethylene glycol dimethacrylate (EGDMA, 98%) crosslinker and 1-octanol (>99%) porogen were purchased from Fisher Scientific (Whitby, ON, Canada). 2,2-dimethoxy-2-phenylacetophenone (DMPA, 99%), photoinitiator was purchased from Sigma Aldrich (Oakville, ON, Canada). Optima LC-MS grade acetonitrile, methanol and formic acid (FA) were obtained from Fisher Scientific (Whitby, ON, Canada). Glacial acetic acid (>99.7%) were purchased from ACP chemicals (Montreal, QC, Canada). Ultrapure water (18.2 MΩ cm⁻¹) was produced by an Milli-Q purification system. For method development and evaluation steps, individual stock solutions of OPPs were prepared in acetonitrile at 1000 mg L⁻¹. For validation studies using the coated mesh, a multi-component mixture of OPPs (4-40 mg L⁻¹) was prepared in methanol. Working solutions of OPPs were prepared in methanol by appropriate dilution of the stock mixture of 5 OPPs at 10 mg L⁻¹. All the solutions were stored at 4° C. until use. Aliquots of the mixtures described above were spiked into samples to obtain required concentrations for each experiment.

### b) Instrumentation and Operating Conditions

Analysis of OPPs were performed using a Waters Acquity ultra-performance liquid chromatography (UPLC) system (Waters, Milford, MA, USA). Chromatographic separation was performed using an ACE C18-PFP column 2.1 mm×150 mm, 3 μm particle size (Canadian Life Science, Canada). The temperature of the column manager was maintained at 30° C. Mobile phase was an isocratic mixture of methanol and water (95:5, v/v) containing 0.1% FA with a flow rate of 0.75 mL min⁻¹. One-μL injections were made using a sample manager maintained at 4° C.

For optimization and validation of molecularly imprinted polymer (MIP)-coated mesh SPME device, 21 OPPs were extracted from water and separated using a Waters Acquity BEH C₁₈ column (2.1×50 mm, 1.7 μm) maintained at 30° C. Gradient elution was employed as shown in Table 1. The injected volume was 5-μL, while samples were maintained at 4° C.

TABLE 1
LC gradient method for separation of selected OPPs.

| Time | Flow rate | Water | methanol | 10% FA |
|---|---|---|---|---|
| (min) | (mL min⁻¹) | % | % | in water |
| Initial | 0.450 | 89 | 10 | 1 |
| 0.5 | 0.450 | 89 | 10 | 1 |
| 3 | 0.450 | 39 | 60 | 1 |
| 4.5 | 0.450 | 24 | 75 | 1 |
| 7.5 | 0.450 | 14 | 85 | 1 |
| 7.51 | 0.450 | 89 | 10 | 1 |
| 8.5 | 0.450 | 89 | 10 | 1 |

For quantitation of OPPs, the UPLC system was interfaced to a triple quadrupole mass spectrometer (Xevo TQ-S, Waters Corp.) equipped with a Z-spray electrospray ionization (ESI) source operated in positive mode under multiple reaction monitoring (MRM) conditions. MRM transitions, cone voltages and collision energies used for all compounds are included in Table 2. Nitrogen was supplied by a generator (Peak Scientific, Scotland, UK) and was used as cone gas as well as desolvation gas, with flow rates of 150 and 1000 L hr⁻1, respectively. Other relevant mass spectrometer parameters were capillary voltages +3.5 kV, source temperature 150° C. and desolvation temperature 650° C.

The analysis of drugs of abuse was performed by a triple quadrupole mass spectrometer Xevo TQ-S (Waters, Milford, MA, USA). An in-house ionization source was used to place the exemplary SPME blades in front of the mass spectrometer. A voltage of 3.5 kv was established between the blade and inlet to introduce ions into the MS. All analyses were carried out in positive ionization mode. MRM transitions, cone voltages and collision energy used for all drugs are included in Table 3.

TABLE 2
Summary of tandem mass spectrometry parameters using LC-MS/MS

| | Precursor | Cone | Product | Collision | Product | Collision |
|---|---|---|---|---|---|---|
| | ion | voltage | ion 1 | energy | ion 2 | energy |
| Pesticide | (m/z) | (V) | (m/z) | (eV) | (m/z) | (eV) |
| Chlorpyrifos | 351.9 | 44 | 96.9 | 30 | 199.9 | 18 |
| Dichlorvos | 221 | 34 | 79 | 34 | 109 | 22 |
| Disulfoton sulfone | 307.1 | 24 | 97.1 | 28 | 153.1 | 12 |
| Paraoxon-methyl | 248 | 36 | 90 | 25 | 202 | 19 |
| Mevinphos | 225.1 | 24 | 127.1 | 15 | 193.1 | 8 |
| Tetrachlorvinphos | 364.8 | 32 | 127 | 16 | 238.9 | 20 |
| Dimethoate | 230.1 | 24 | 125 | 20 | 199 | 10 |
| Demeton-S-methyl | 231.1 | 16 | 61.2 | 30 | 89.1 | 10 |
| Ethoprophos | 243.2 | 32 | 97 | 31 | 131 | 20 |
| Parathion methyl | 263.9 | 38 | 79 | 36 | 109 | 22 |
| Tolclofos-methyl | 301 | 41 | 125 | 29 | 174.9 | 17 |
| Methidathion | 303 | 18 | 85.1 | 20 | 145 | 10 |
| Fenamiphos | 304.1 | 30 | 201.9 | 34 | 216.9 | 22 |
| Diazinon | 305.1 | 16 | 153.1 | 18 | 169.1 | 20 |
| Pirimiphos-methyl | 306.1 | 36 | 108.1 | 32 | 164.1 | 22 |
| Azinphos-methyl | 318 | 20 | 160 | 18 | 261 | 8 |
| Malathion | 331 | 18 | 99 | 20 | 127 | 10 |
| Prothiofos | 345.2 | 30 | 133 | 20 | 241 | 20 |
| Profenofos | 372.9 | 36 | 127.9 | 40 | 302.6 | 20 |
| Pyrazophos | 374 | 44 | 194 | 32 | 222.1 | 22 |
| Ethion | 385 | 25 | 171 | 20 | 199 | 10 |

TABLE 3
Summary of tandem mass spectrometry parameters for
drugs using direct MS/MS analysis.

| | Precursor | Cone | Product ion | Collision |
|---|---|---|---|---|
| Compound | ion (m/z) | voltage (V) | 1 (m/z) | energy (eV) |
| Cocaine | 304.12 | 30 | 182.13 | 30 |
| Methamphetamine | 150 | 30 | 91.1 | 27 |
| MDMA | 194.2 | 30 | 163.1 | 19 |
| Methadone | 310.1 | 30 | 265 | 19 |
| Methadone-d3 | 313.2 | 30 | 268.3 | 13 |

### c) High-Throughput Fabrication Technique

### i) Prepolymer Solution Formulations

i. Prepolymer composition used for preparing exemplary polymer coated SPME blades used for detection of drugs of abuse:

### Formula I:

| | |
|---|---|
| 4-VP | (8.5 mL) |
| EGDMA | (75.5 mL) |
| DMPA | (1.6 gr) |
| 1-octanol | (100 mL) |

ii. Prepolymer composition used for preparing exemplary polymer coated SPME blades for detecting OPPs:

### Formula II:

| | |
|---|---|
| MAA | (678 μL) |
| EGDMA | (9050 μL) |
| DMPA | (160 mg) |
| 1-octanol | (10 mL) |

Formula II a to d: Formula II with added (triphenyl phosphine) TPP.

The amount of TPP can be varied depending on the monomer and can be optimized for a certain prepolymer composition. The selection of stabilizer and amount of stabilizer in relation to the monomer would be within the purview of a person skilled in the art. For Formula II, 4% and 10% TPP results in polymeric coating on metal sheets in ambient conditions without nitrogen. Formula IIb with 4% TPP yielded the more stable coating of the tested formulations.

Formula IIa: 1% TPP: 5 mL solution Formula II+50 mg (triphenyl phosphine) TPP
Formula IIb 4% TPP: 5 mL solution+200 mg TPP
Formula IIc 10% TPP: 5 mL solution+500 mg TPP
Formula IId 15% TPP: 7.5 mL solution+1000 mg TPP

Formula II was used for preparing exemplary polymer coated SPME blades for detecting OPPs.

iii. Prepolymer composition used for preparing exemplary MIP-coated mesh devices for detection of OPPs.

### Formula III

Template: 2-{[diethoxy(sulfanylidene)-λ-phosphanyl]amino}acetic acid: 6.82 mg (30 mmol)

| | |
|---|---|
| MAA | (10.175 mL) (120 mmol) |
| EGDMA | (90.5 mL) (480 mmol) |
| DMPA | (1.6 g) |
| 1-octanol | (112.5 mL) |

iv. Prepolymer composition used for preparing exemplary NIP-coated SPME mesh devices for detection of OPPs.

### Formula IV

| | |
|---|---|
| MAA | (10.175 mL) (120 mmol) |
| EGDMA | (90.5 mL) (480 mmol) |
| DMPA | (1.6 mg) |
| 1-octanol | (112.5 mL) |

### ii) Exemplary Thin Film Coated Solid Phase Microextraction Blades:

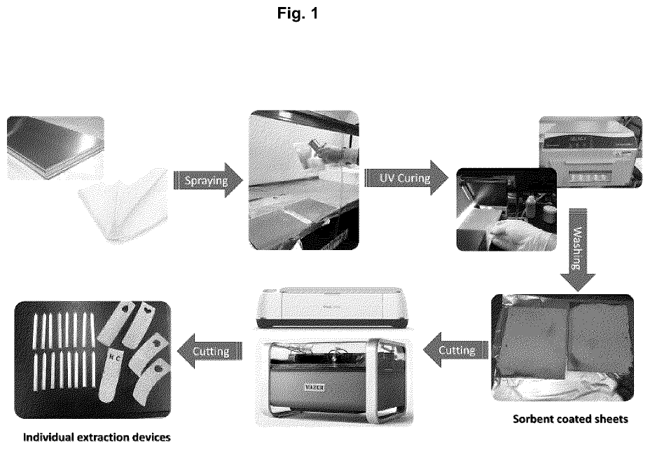

For the preparation of thin film coatings, stainless steel (medical grade, 316 type, gauge 20, 0.81 mm thickness) and fiberglass sheets were used as the support substrate. Prior to spraying the prepolymer solution, the metallic sheets (20 cm²) were uniformly sanded using commercial sandpaper (150) which allows for better adhesion of the coating to the substrate. The metallic sheets were then cleaned with methanol and dried using a gentle stream of nitrogen. The prepolymer solution used to form the adsorptive coating was prepared with a mixture containing any ratio of any monomer, crosslinker, initiator, solvent and any additives or components, for example, by using the formulations (Formula I or Formula II) described above, by thoroughly mixing and degassing the solution in an ultrasonic bath for 5 minutes. The prepared prepolymer solution was evenly sprayed on the metallic support sheets. In initial trials the prepolymer solution was sprayed on the using a sprayer bottle. For the example described herein a paint spray gun (HVLP gravity-feed paint spray gun) was used to spray the prepolymer solution on the support sheet. The pressure used for spraying was 30 psi. The spray should be performed in a way that provides a full coverage of the surface of the support sheet. The sprayed metallic support sheet was placed in a custom-made glove box under a nitrogen environment. After purging the box with N₂, once the oxygen content is lower than 2%, the polymerization was conducted using UV light (254 nm) for 30 mins (Fisherbrand™ UV Crosslinker). Following polymerization, the coated metal support sheets were washed with methanol. The dried coated metal support sheets were cut into 5.0 mm (width)×60 mm using a waterjet cutter (WAZER, USA). In order to obtain desirable length of coating, some coated parts can be removed. The prepared extraction devices were then rinsed using methanol (30 min at 500 rpm), dried and stored at room temperature until further use (FIG. 1).

iii) Exemplary Polymer-Coated Mesh Solid Phase Microextraction Devices:

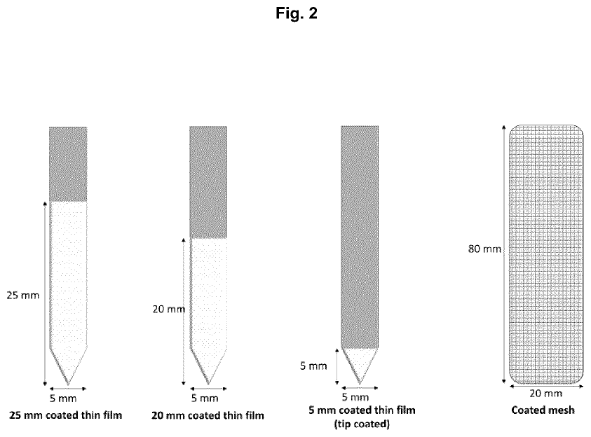

2 oz Fiberglass mesh fabric was cut using paper trimmer into 20 cm² and laid over second metallic support sheets. The second metallic support substrate was used in order to help achieve a uniform spray as well as for easy handling to the UV conveyer. The exemplary prepolymer compositions used for mesh microextraction devices were Formula III and Formula IV described above. Spraying can also be done on the fiberglass mesh without a second support sheet. Spraying was performed using the same apparatus and setting as for the exemplary thin film coated SPME blades described above. Again, the spraying should be performed in a way that provide a full coverage of the surface of the fiberglass mesh and the second support sheet. To prepare adsorptive coating on fiberglass sheets, these support sheets can be directly sprayed with prepolymer solution with no pretreatment steps. Without being bound by theory, this is thought to be mainly due to high adhesion of the polymer to the substrate. After polymerization in a UV conveyor oven (for 1 min) in air, a uniform layer of the polymer was formed on the glass fibers. The polymer-coated mesh sheet was washed with methanol several times to remove the residual unreacted materials. Following that, the coated sheets were cut using a hand-craft cutter (Cricut Maker®) into 20 mm×80 mm strips. The cut strips were then rinsed with methanol (30 min at 500 rpm), conditioned in a vacuum oven (150 C. for 24 hours) and stored at room temperature until use. Some of the exemplary extraction devices are demonstrated in FIG. 2.

### d) Sample Preparation Procedure

### i) Extraction of OPPs From Water Samples

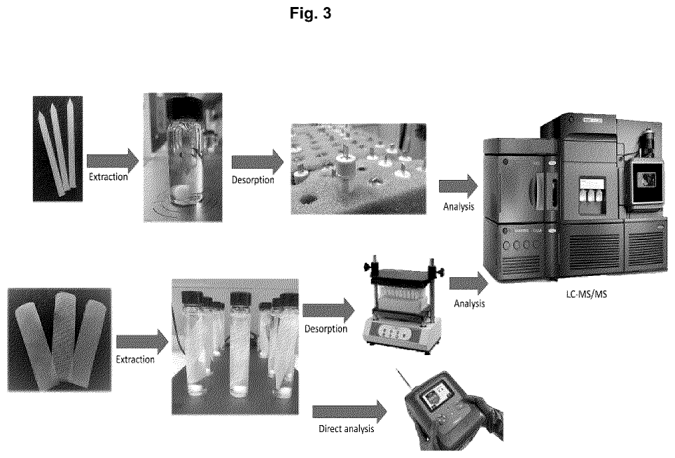

For the extraction of OPPs, standard solutions were prepared in 40 ml ultrapure water by spiking multi-mix standards (<1% of the sample volume) and were used immediately to avoid adsorption of analytes to the walls of the glass vial. The prepared exemplary thin films SPME devices using the prepolymer composition of Formula II were directly exposed to the aqueous solutions with no preconditioning. The enrichment of analytes was performed by stirring at 1000 rpm for 60 min at room temperature. After that, the exemplary thin films SPME devices were washed with 1-2 mL of ultrapure water and allowed to dry. Desorption was performed in 500 μL methanol using a vortex agitator stirred at 1000 rpm for 30 min. For analysis of samples, 1 μL of desorbed extract was injected into a LC/MS-MS (FIG. 3). Exemplary sorbent-coated mesh SPME devices were immersed in 40 mL of the OPPs mixed standard solution with concentration ranges of 10-100 ng mL⁻¹ for 30 min agitated at 1000 rpm. The exemplary MIP or NIP mesh SPME devices were then removed from vials and allowed to air dry. For desorption of analytes, the mesh was folded and placed in a 5.0 mL screw cap PP centrifuge tube (Eppendorf) with 2 mL methanol agitated at 1500 rpm for 30 min. The extraction and desorption processes were carried out in a high throughput manner utilizing multi-position stirrer and vortex mixing devices, respectively. Following desorption, the methanol containing the desorbed analytes was filtered using a 0.22 μm filter and injected to the LC/MS-MS system.

### ii) Extraction of Drugs of Abuse From Biological Samples:

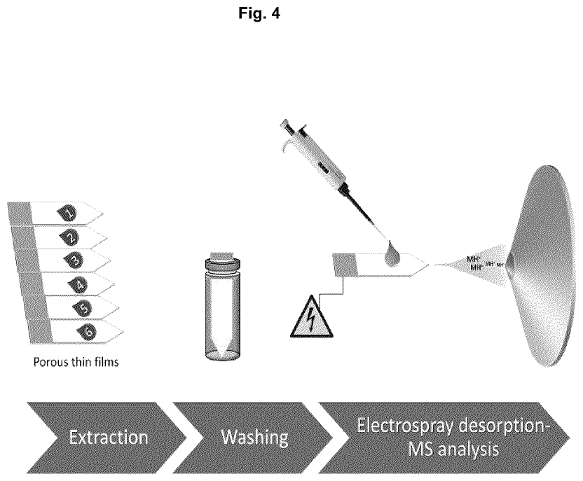

The process for extraction of drugs from biological samples comprises, for example, of three steps namely spot sampling, washing and electrospray solvent desorption (FIG. 4). Urine and plasma samples were spiked with 25 ng mL⁻¹ of cocaine, methamphetamine, MDMA and methadone. The extraction starts with spotting 10 μL of sample onto the exemplary SPME blade coated with polymeric sorbent prepared using the prepolymer composition of Formula I. After 1 min static extraction, the exemplary SPME blade was washed with 1 mL water to remove potential interfering substances from matrix components. After drying, the exemplary SPME blade was placed in front of MS inlet using a clamp. The analysis was performed by applying the voltage followed by depositing 10 μL desorption solvent (methanol: water, 9:1, v/v containing 0.1% FA). The total run time for electrospray desorption was 1 min.

### B. Results and Discussion

### a) High Throughput Preparation of Porous Extraction Devices

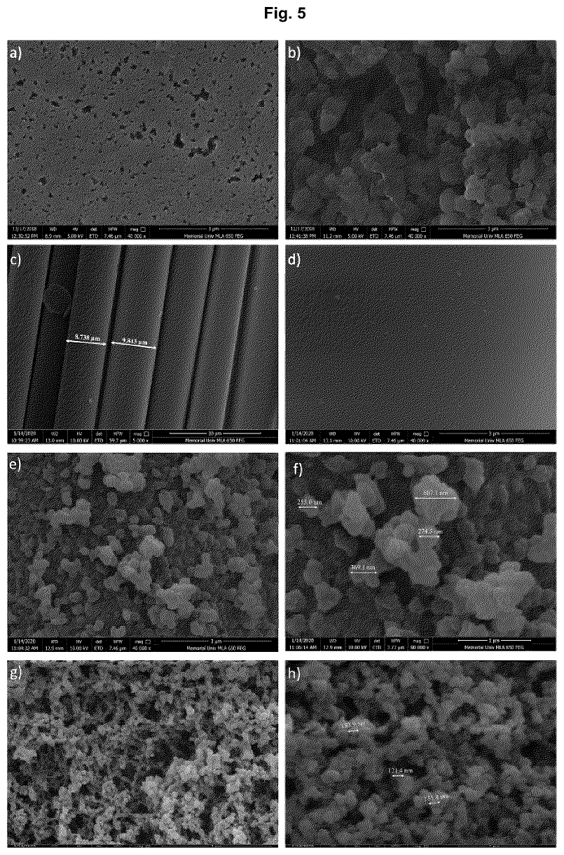

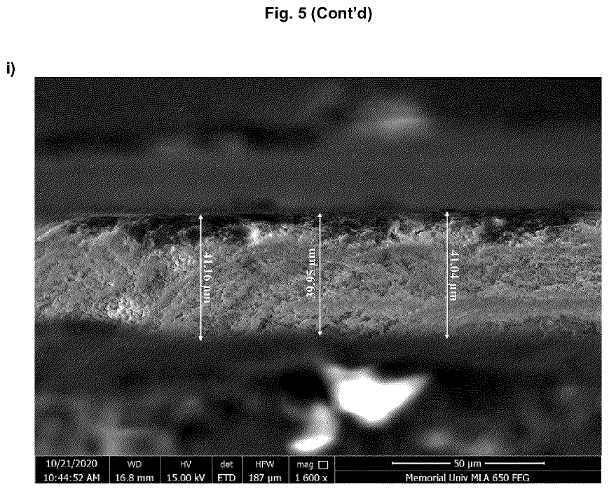

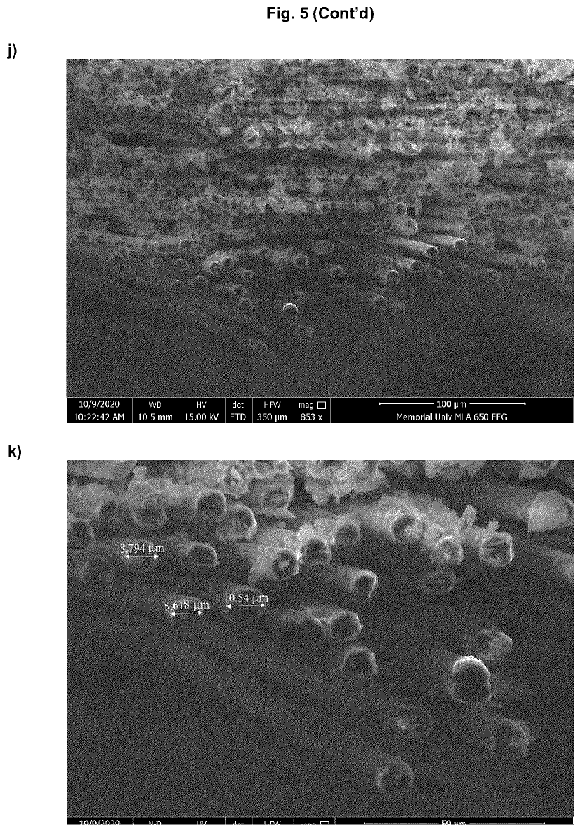

To characterize the morphology of sorbent, scanning electron microscopy (SEM) was implemented. FIG. 5 shows the scanning electron micrographs of the sorbents prepared by different techniques and support substrates. FIG. 5a) demonstrates a exemplary thin film SPME device prepared via drop casting technique [29]. Covering the thin layer of prepolymerization solution (Formula I) by drop-casting results in a flat surface (FIG. 5a) on the surface of the sorbent which may affect the accessibility of the sorbent towards the targeted analytes. Moreover, drop casting may result in adhesion of the polymer to the cover and low yield of producing individual devices. Using, for example, a spray technique for fabrication of polymer sorbent using Formula I on metallic support sheets (FIG. 5b) results in superficial porosity of the surface. This porous structure can provide more surface area which can lead to an easier and faster access of the analytes to the sorbent. The polymer coating prepared by spraying a prepolymer solution of Formula I demonstrates a particle size of about 400 nm. It was also determined by SEM that the thickness of the polymer coated metallic support sheet using Formula I as the prepolymer prepared by spraying is about 828 μm to about 835 μm. The metallic support sheet has a thickness of 810 μm. Accordingly, the thickness of the polymeric coating layer is about 18 μm to about 25 μm. Without being limited by theory, a thickness of the polymer coating Less than 10 μm on the metallic support sheet would be expected to lead to instable coating and coating with thickness >100 μm would be expected to lead to insufficient functioning such as incomplete desorption. FIG. 5 i) shows a cross section of exemplary polymer coated stainless steel SPME device (blade) cut using waterjet cutting and prepared from prepolymer composition of Formula I. The thickness of the polymer coating layer on the exemplary polymer coated stainless steel SPME device was found to be 41.16 μm, 39.95 μm and 41.04 μm at the measured positions.

Other than metallic sheets, the prepolymerization solutions (Formula III and Formula IV) were also sprayed onto fiber glass support sheets. The smooth and inert surface of this support substrate is shown in FIG. 5c) and FIG. 5d). These support sheets have a great potential to be used as support substrate for sprayed prepolymer solutions. Each fiber has a diameter of less than 10 μm which results higher surface area compared to metallic support sheets. Therefore, the polymerization was performed within 1 min. FIG. 5e) and FIG. 5f) illustrates the porous sorptive NIP polymer material prepared via Formula IV described above. As can be observed, a porous polymer is well-formed using such a fast UV-polymerization step. The surface has a porosity very close to coated metallic sheets and. The particle size of the NIP polymeric coating prepared via Formula IV was in the range of 250-600 nm. A more homogenous polymeric coating was obtained using MIP sorptive materials prepared for adsorption of OPPs (Formula III described above). As shown in FIG. 5g) and FIG. 5h), the MIP (prepared using Formula III described above) coating demonstrates less aggregation and smaller particle size (<150 nm). This homogeneity and higher surface area will result in high adsorption capacity and improved performance which will be discussed in greater detail below. FIG. 5j) and FIG. 5k) show a cross section of an exemplary polymer coated fiberglass mesh SPME device prepared with prepolymer composition of Formula III. The diameters of the representative fiberglass fibers were measured and found to be 8.794 μm, 8.618 μm and 10.54 μm. As seen in FIG. 5j) and FIG. 5k), the thickness of the polymer coating layer on the fiberglass mesh support is less than the diameter of the fiberglass fibers. Accordingly, it was surprisingly found that a polymer coating layer having a thickness of less 10 μm is stable. Without being bound by theory, the interconnectivity of the fiberglass fibers provides stability to the polymer coating layer.

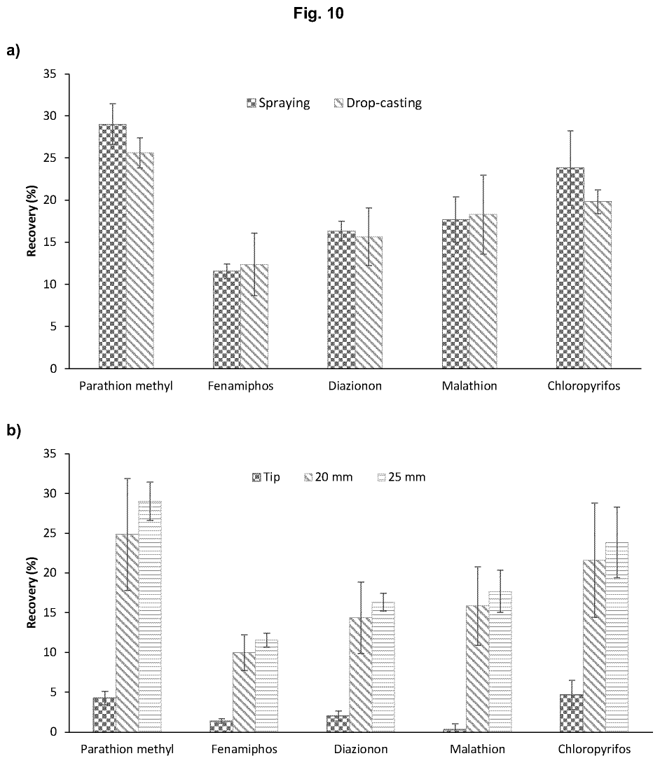

Once the prepolymer composition is deposited on the surface of support substrate using any technique known in the art, e.g., drop-casting, spraying, brushing and/or dipping), it can be cured and used for extraction. The spraying technique over another of the other techniques offers the possibility for automation and reproducibility of batch production. A primary study to compare drop-casting technique to prepare individual devices similar to ones prepared in the literature versus spraying technique to prepare plural of extraction devices for sorption of OPPs from water samples using three individual devices per each technique. A similar prepolymer solution (Formula II as described above) was used for both techniques. FIG. 10a) shows that the spraying technique resulted in similar extraction efficiency and improved reproducibility in comparison with drop-casting technique.

A comparison between a comparative thin film SPME device prepared by spraying pre-cut metallic SPME blades with an exemplary thin film SPME device as prepared by cutting metallic support sheets coated with sorptive materials using Formula I (FIG. 6) as described herein was performed. As shown in FIG. 6a), spraying over pre-cut metallic blades SPME device results in thin film with edges where polymerization will not occur due to diffusion of oxygen. This effect creates a heterogenous polymer around the edges. However, using the spraying/waterjet cutting technology described herein allows for preparation a homogeneous coating over metallic blades (FIG. 6b). Although there are some artefacts around the edges due to the pressure of waterjet cutter, this limitation can be overcome by further optimization of the effective parameters of the cutting device such as pressure, type of nozzle, etc.

### b) Extraction of Analytes Using Exemplary Porous Solid Phase Microextraction (SPME) Devices

### i) Inter Device Variability

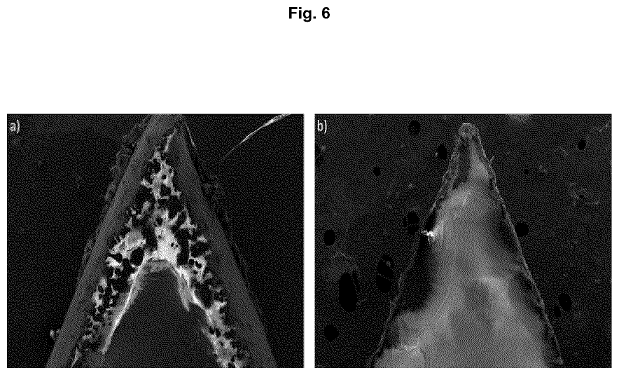

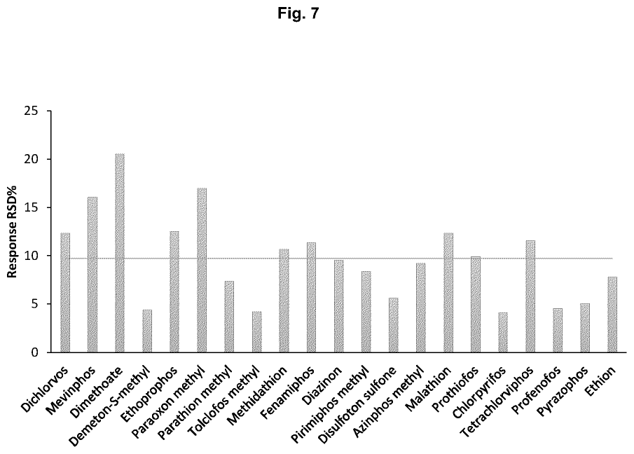

One of the problems associated with laboratory-made microextraction devices is poor inter-device repeatability. These variations necessitate device reuse for calibration and sample analysis to obtain acceptable analytical data. The process of the application uses a reproducible depositing technique, for example, spraying technique to prepare porous phase-coated microextraction devices such as porous phase-coated microextraction mesh devices which reduces inter-device variability. To assess inter-device variability and demonstrate the potential of these devices for single use applications, 15 individual exemplary mesh SPME devices prepared with a prepolymer composition of Formula III were used to extract OPPs. FIG. 7 illustrates the RSD % values of these 15 experiments. The average of RSD values was less than 10% with no internal standard added, demonstrating excellent reproducibility.

### ii) Desorption of Analytes From Exemplary Porous Solid Phase Microextraction (SPME) Devices

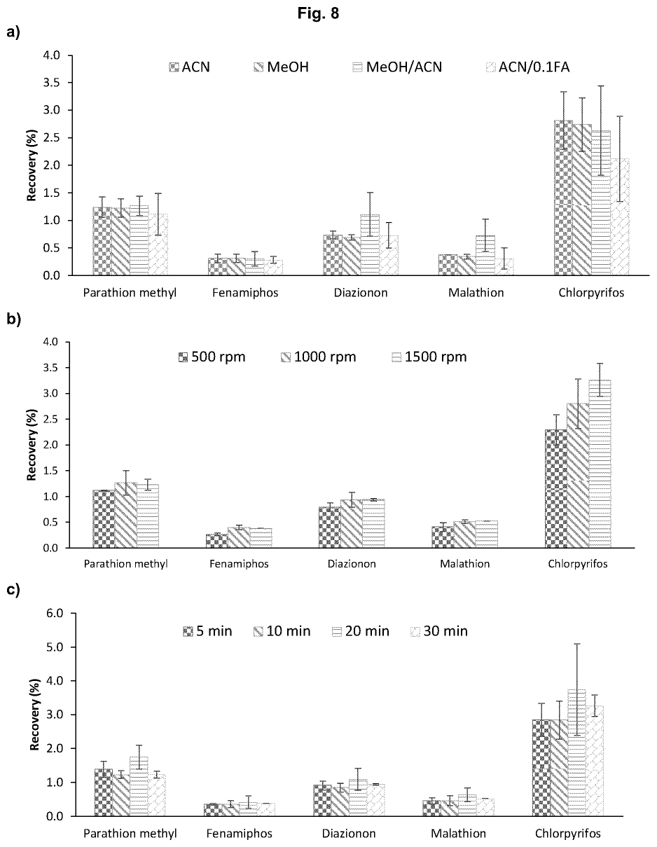

The desorption process of OPPs from the exemplary tip-coated SPME devices prepared using Formula II was optimized by studying three effective parameters: the type of the organic solvent, the agitation speed and the desorption time. The desorption solvent should have the ability to dissolve the analyte and should be compatible with the sorbent and the analytical instrument. These criteria, when met, should result in reproducible analytical data. Results from the type of organic solvent study are represented in FIG. 8a). High physical stability of the above described polymer makes it compatible with most of the available organic solvents. However, as can be seen in FIG. 8a), RSD reported for some of solvents such as mixtures of methanol/acetonitrile and 0.1% FA in acetonitrile is not good. Furthermore, there is not a huge difference between the two organic solvents (methanol and acetonitrile). Therefore, methanol was selected as the desorption solvent because of its reproducible results and its compatibility with chromatographic separation.

FIG. 8b) shows that the desorption efficiency has been increased by raising the desorption agitation rate, especially for more hydrophobic analytes such as chlorpyrifos. As a result, the highest agitation rate studied, 1500 rpm, was chosen for the rest of the study. The outcome of desorption time investigation illustrates in FIG. 8c). Desorption time should be long enough to provide complete desorption of analytes. In addition, spending excess time on sample preparation can add cost and make the analytical method more tedious. Based on the results from FIG. 8c), there is no significant different between various desorption times. Without being bound by theory, this is attributed the porous structure of the prepared polymer coating which allow for easy accessibility of adsorption sites for desorption solvent. Therefore, using such porous polymeric sorbent coatings allows for short desorption time and avoids multi steps. 30 min was selected as the optimized desorption time to ensure the complete desorption of analytes.

iii) Extraction Time Profile for Exemplary Solid Phase Microextraction Blades-Coated Porous Polymer

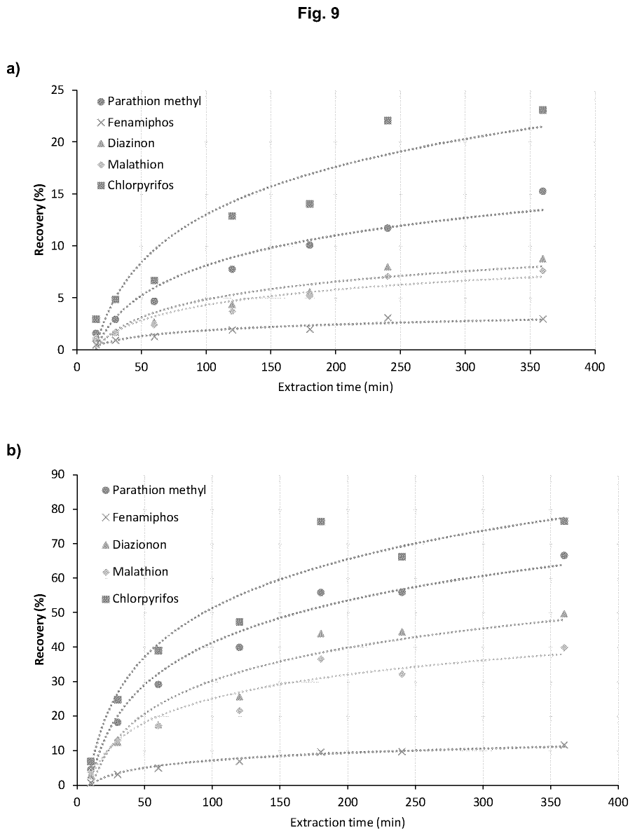

Extraction time is one of the parameters that should be optimized in different extraction techniques. FIG. 9a) demonstrates the extraction time profile of OPPs using exemplary tip-coated SPME devices prepared using a prepolymer composition of Formula II. According to the result demonstrated in this graph, it can be concluded that extraction mechanism of the exemplary thin film SPME device is similar to SPME extraction theory [14]. This mechanism is based on the partitioning of the analyte between the sorbent and the sample solution. The extracted amount of analyte will increase as exposure time increases until it reaches equilibrium. For some of the OPPs such as fenamiphos or malathion, the analytes reached equilibrium within 240 minutes but some analytes such as chlorpyrifos took longer to equilibrate. The exemplary SPME devices can be used for extraction of analytes from non-depletive extraction to near-exhaustive and exhaustive extractions.

As discussed above, low extraction efficiencies can be obtained using exemplary tip-coated SPME blades. Volume of the extraction phase (or amount of extract) is one of the parameters which can change the extraction efficiency [20]. In an experiment performed using exemplary 20 mm-coated SPME blades using Formula II, higher extraction efficiency of OPPs from 20 mL samples was obtained (FIG. 9b). For example, extraction efficiency of chlorpyrifos was obtained ˜80% in comparison with ˜25% using tip coated SPME blades after 6 h. Further investigation of the coated length of SPME blades can be obtained by comparing the extraction efficiencies using three different exemplary SPME devices (shown in FIG. 2) from a same sample solution. As demonstrated in FIG. 10b), the recovery of all analytes was increased using larger amount of the sorbent prepared using Formula II.

### iv) Extraction Time Profile Using Exemplary Solid Phase Microextraction (SPME) Mesh-Coated Porous Sorptive Polymer:

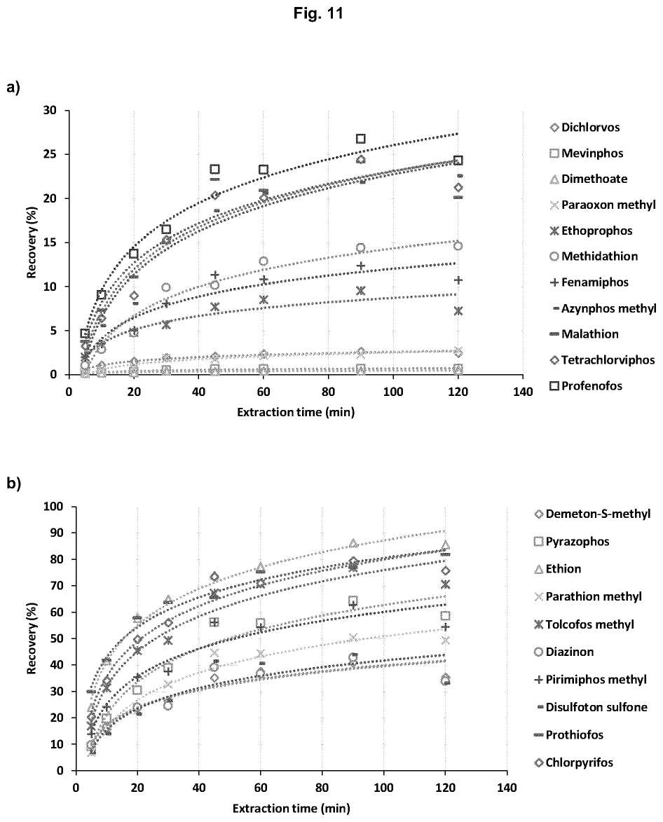

FIG. 11 represents the extraction time profile for 21 OPPs operated by exemplary SPME mesh-coated sorptive polymer prepared using a prepolymer composition of Formula IV. Increasing the exposure time enhances the extraction efficiency of the analytes before reaching top the equilibrium. A similar trend can be seen by comparing the graphs in FIG. 9. However, the pesticides reached equilibrium much faster than the thin film SPME device and most of them reached equilibrium within 60 minutes. This behavior can be explained by an increasing mass of sorbent coated on the mesh SPME device as compared to the thin film SPME device. More surface area can increase the rate of the extraction [36].

According to the following formula, which is defined the extraction rate in SPME devices, the rate is proportional to the surface area of the sorbent (A), the diffusion coefficient of the analyte (Dₛ), and the concentration of the analytes in the sample (Cₛ) and inversely proportional to the thickness of the boundary layer (δₛ).

$$\frac{dn}{dt} = ( \frac{{D}_{s} A}{{δ}_{s}} ) {C}_{s}$$

High surface area, ease of use and rapid extraction make mesh-coated sorptive SPME device an ideal device for fast analysis of water or food analysis. The extraction time profile for a group of pesticides can help in determining a sufficient extraction time to reach the desired sensitivity.

### v) Exemplary Molecularly Imprinted Polymers-Selective Sorbents Coated Solid Phase Microextraction (SPME) Devices

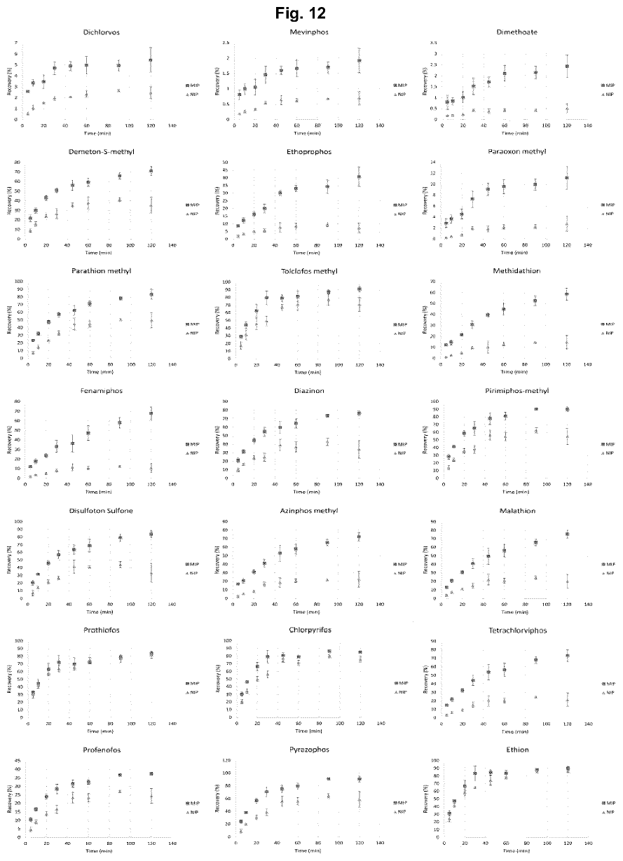

One of the parameters that affects the sensitivity of the analysis and extracted mass using extraction techniques is the affinity of the sorbent towards target analytes. One way to improve this affinity is using MIPs as the coating. MIPs were prepared using a prepolymer composition of Formula III in a fiberglass mesh SPME device format for extraction of OPPs from water samples and its performance was compared with a non-imprinted polymer (NIPs) fiberglass mesh SPME device prepared using Formula IV. The selectivity of the exemplary MIP-coated mesh device for adsorption of 21 selected OPPs was compared to NIP-coated mesh device with extraction time between 5 and 120 min (FIG. 12). Equilibrium conditions were attained quickly for the more polar analytes such as dichlorvos, mevinphos and dimethoate, due to low LogP which results in low portioning into the sorbent. As is well illustrated by their extraction time profiles, using a selective MIP coating for these analytes is advantageous as the MIP has the benefit of templated sites with higher affinities for these analytes. Some researchers believe that NIPs possess only non-specific binding sites with lower affinity for analytes, therefore equilibrium extraction is longer for NIPs [37]. It is thought that the MIPs have a more selective binding sites that are also readily accessible to the analytes, which shortens the time to equilibrium [38].

Further evidence for the extraction mechanism can be elucidated from the extraction time profiles of the analytes with the higher selectivity values, specifically fenamiphos and ethoprophos (FIG. 12). Each of these analytes reached equilibrium conditions within 45 min for the NIPs, while the extraction using MIP coating continued to increase even after 120 min. This long equilibrium for MIPs can be attributed to a larger number of available binding. This enhancement can also be due to higher affinity and larger partition coefficient of these analytes between sample solution and MIP coating compared with sample solution and NIP coating. Although the NIP materials have large adsorption capacity demonstrated through exhaustive or near exhaustive extraction of analytes such as prothiofos, ethion and chlorpyrifos, the evidence supports conclusions that the MIPs have a larger adsorption capacity, higher affinity binding sites and perhaps higher surface area related to the porosity of the MIP material. The higher surface area was also observed in FIG. 5. The favorable binding site energy and porosity in the MIPs allow for faster equilibration for analytes with low relative selectivity such as chlorpyrifos and ethion (FIG. 12). This demonstrates the availability or affinity of selective binding sites for adsorption of those analytes. Therefore, an extraction mechanism using MIP based extraction devices involves both the nature of analytes and properties of the binding sites in addition to porosity and capacity. Since the only difference is the presence of template molecules, selective binding sites are created and promote the interaction particularly for analytes with lower extraction efficiency.

### iv) Method Validation for Determination of OPPs

The optimized analytical method which employs the exemplary SPME fiberglass mesh-coated sorptive phase prepolymer composition of Formula III and fabricated by the spray technique was validated by analyzing OPPs in water. Table 4 shows the figures of merits for this method. The reported limit of quantification (LOQ) is defined as the lowest spiked concentration with RSD of triplicate analysis less than 20%. The LOD and LOQ were 0.0005-0.5 ng mL¹ and 0.00125-1 pg mL⁻¹ respectively.

TABLE 4
Figures of merit for determination of OPPs in water using mesh solid phase
microextraction device-coated porous sorptive polymer.

| | LOD | LOQ | | | Recovery |
|---|---|---|---|---|---|
| OPPs | (ng mL⁻¹) | (ng mL⁻¹) | Function | R² | (%)^{a} |
| Demeton-S- | 0.5 | 1 | y = 3241.2x + 1030.8 | 0.9656 | 26.4 |
| methyl | | | | | |
| Ethoprophos | 0.05 | 0.125 | y = 30783x − 1490.2 | 0.9992 | 5.7 |
| Parathion methyl | 0.025 | 0.05 | y = 12214x + 742.07 | 0.9992 | 32.9 |
| Tolcofos methyl | 0.0025 | 0.005 | y = 35787x + 4029.2 | 0.996 | 49.4 |
| Methidathion | 0.025 | 0.05 | y = 2543x + 32.4 | 0.993 | 9.9 |
| Fenamiphos | 0.0025 | 0.005 | y = 82058x + 2688.3 | 0.9913 | 8.1 |
| Diazinon | 0.0005 | 0.00125 | y = 1761556x x + 731957 | 0.9968 | 24.5 |
| Pirimiphos methyl | 0.0005 | 0.001 | y = 1486983.7x + 143399.7 | 0.9962 | 37.7 |
| Disulfoton sulfone | 0.0125 | 0.025 | y = 31905x + 1382.4 | 0.9969 | 26.5 |
| Azynphos methyl | 0.4 | 0.1 | y = 992.47x + 66.754 | 0.9979 | 16.5 |
| Malathion | 0.005 | 0.01 | y = 28553x + 525.59 | 0.9968 | 15.0 |
| Prothiofos | 0.002 | 0.005 | y = 87238x + 211.08 | 0.9996 | 63.7 |
| Chlorpyrifos | 0.015 | 0.03 | y = 82306x + 16774 | 0.9991 | 56.1 |
| Tetrachlorviphos | 0.005 | 0.0125 | y = 57011x + 1560.5 | 0.9977 | 15.3 |
| Profenofos | 0.002 | 0.005 | y = 52523x + 15075 | 0.9923 | 16.5 |
| Pyrazophos | 0.00125 | 0.0025 | y = 309058x + 102752 | 0.9958 | 39.0 |
| Ethion | 0.005 | 0.01 | y = 95062x + 9296.3 | 0.9952 | 64.9 |

^{a}The recovery values are for 30-min extraction time.

The data reported in table 4 was obtained using a 30-minute extraction. Therefore, a longer extraction time can result in a lower LOQ and higher recovery. The acquired recovery of seventeen pesticides were between 5 to 64.9%, so exhaustive extraction is feasible by increasing the extraction time.

### c) The Potential of Employing Polymer Coated Solid Phase Microextraction Blades as an Interface for Direct Coupling to Mass Spectrometers

The SPME metallic blade preparation method was applied with a polymer suitable for the analysis of drugs of abuse in bodily fluids (Formula I as described above). The exemplary SPME blades can extract drugs of abuse from fluid samples such as urine and plasma before being directly coupled to a mass spectrometer for analysis. Directly coupling extraction devices to the final analytical instrument eliminates many sample preparation steps as well as eliminating front-end separations such as GC or LC analysis. Table 5 demonstrates the working range and figures of merit for our devices for the analysis of selected drugs of abuse.

TABLE 5
Figures of merit for drug of abuse analysis (DOA)
through exemplary coated SPME blades.

| | Linear | LOD | LOQ | | |
|---|---|---|---|---|---|
| | range | (ng | (ng | | |
| Compound | (ng mL⁻¹) | mL⁻¹) | mL⁻¹) | slope | R² |
| Cocaine | 0.1-50 | 0.09 | 0.24 | 161698 | 0.9978 |
| Methamphetamine | 0.1-100 | 0.09 | 0.26 | 35957 | 0.9944 |
| MDMA | 0.1-100 | 0.06 | 0.11 | 31622 | 0.9963 |
| Methadone | 0.1-100 | 0.09 | 0.25 | 157531 | 0.9967 |
| Methadone-D3 | 0.1-100 | 0.09 | 0.24 | 53975 | 0.9960 |

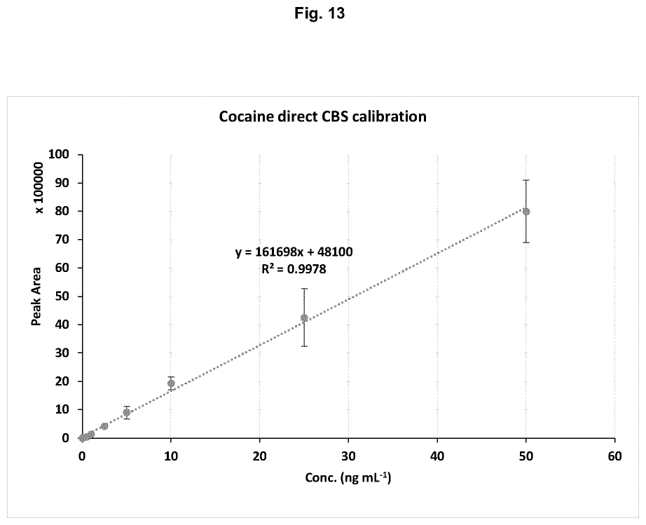

The calibration generated from the exemplary SPME blades (FIG. 13) is of high analytical merit meaning that the relationship between instrument response and concentration extracted on the blade is linear.

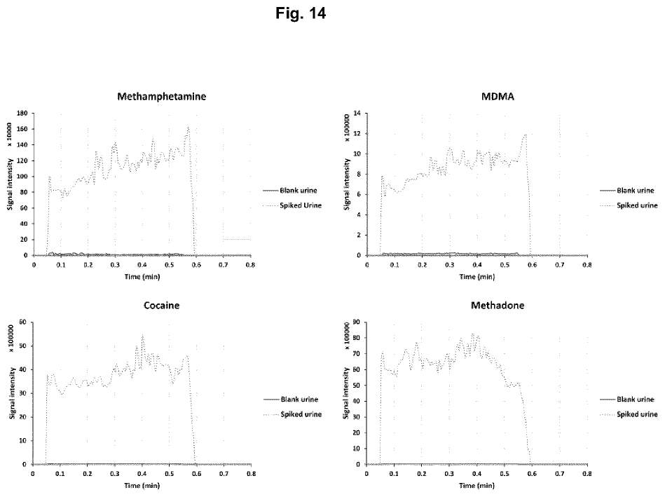

The direct introduction of biological samples into MS by direct coupling the polymer coated SPME blade (Formula I) using inhouse ion-source to MS (FIG. 14) was assessed. The summary of this study is presented in Table 6. Sub-part per billion concentration as LOD and LOQ for determination of drugs in different samples demonstrate excellent suitability of proposed sorbent as an interface for direct measurement using MS.

TABLE 6
Figures of merit for determination drug of abuse analysis (DOA) in biological
samples using exemplary coated solid phase microextraction (SPME) device blades

| | | LR | LOD | LOQ | | |
|---|---|---|---|---|---|---|
| Analyte | sample | (ng mL⁻¹) | (ng mL⁻¹) | (ng mL⁻¹) | Function | R² |
| Cocaine | Synth urine | 1-100 | 0.005 | 0.02 | y = 14304x − 13752 | 0.9997 |
| | Male urine | 1-100 | 0.07 | 0.23 | y = 32473x + 47123 | 0.9994 |
| | Human urine | 1-100 | 0.10 | 0.34 | y = 15995x − 9738.7 | 0.9999 |
| | Plasma | 1-100 | 0.02 | 0.05 | y = 25667x + 33365 | 0.9984 |
| Methamphetamine | Synth urine | 1-100 | 0.03 | 0.1 | y = 2612.1x − 926.33 | 0.9999 |
| | Male urine | 1-100 | 0.12 | 0.4 | y = 10141x + 7805 | 0.9999 |
| | Human urine | 1-100 | 0.4 | 1.2 | y = 3893.3x − 630.87 | 0.9998 |
| | Plasma | 1-100 | 0.3 | 0.8 | y = 3663.9x + 9742.8 | 0.9991 |
| MDMA | Synth urine | 1-100 | 0.03 | 0.09 | y = 4536.5x − 2559.4 | 0.9998 |
| | Male urine | 1-100 | 0.6 | 2.1 | y = 7743.5x + 10057 | 0.9998 |
| | Human urine | 1-100 | 0.4 | 1.3 | y = 2576.8x + 3379.8 | 0.9999 |
| | Plasma | 1-100 | 0.05 | 0.16 | y = 2267.7x + 5063.8 | 0.9993 |
| Methadone | Synth urine | 1-100 | 0.004 | 0.01 | y = 11799x − 15542 | 0.9995 |
| | Male urine | 1-100 | 0.06 | 0.21 | y = 49690x + 96085 | 0.9990 |
| | Human urine | 1-100 | 0.2 | 0.8 | y = 17442x + 6154.8 | 0.9999 |
| | Plasma | 1-100 | 0.01 | 0.03 | y = 27775x + 37512 | 0.9992 |

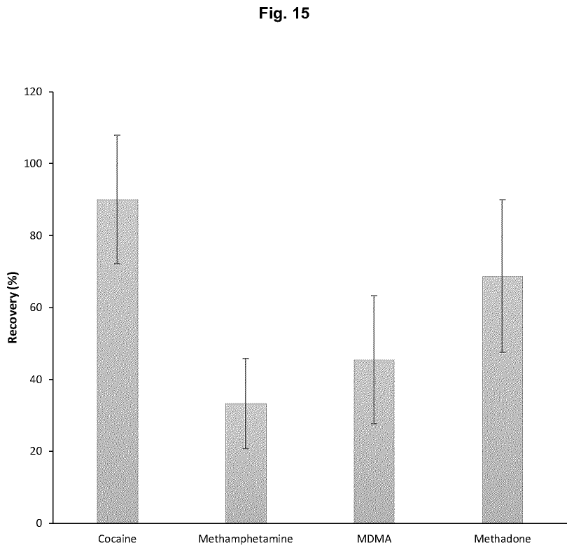

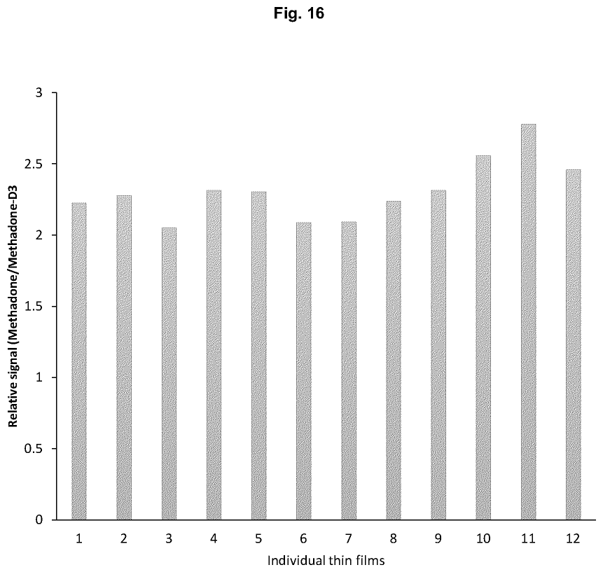

Direct introduction of biological samples can be detrimental to the instrument due to matrix components that can cause contamination of MS. Additionally, these substances would lead to signal suppression and poor analytical performance. Extraction and isolation of analytes of interest is considered as a key solution. A static extraction was performed for 1 min for enrichment of drugs by spotting 10 μL of urine sample on exemplary sorbent coated solid phase microextraction (SPME) blades. The polymer sorbent coating prepared with prepolymer composition of Formula I as described above can be used for spot-sampling without any preconditioning steps (30 min with a 50:50 (methanol/water, v/v) solution) [39]. This is mainly due to wettability of porous thin film. Thus, the exemplary thin film solid phase microextraction (SPME) devices of the application are advantageous over coated blades reported in the literature due to reducing the time and resources required for biological analysis. After extraction, the exemplary SPME blades were washed using water to remove matrix components. The analysis and desorption were conducted using 10 μL elution solvent (methanol:water, 9:1, v/v containing 0.1% FA) along with high voltage. The efficiency of blades for extraction of drugs are demonstrated in FIG. 15. As demonstrated, the exemplary coated thin films extraction devices have a great affinity for these analytes, 33% to 90% extraction efficiency for 1 min extraction. High SD values which are obtained without internal standard correction is due to the sample introduction into MS. Therefore, a study to assess the variability of signal intensity of spot sampling with internal standard addition was performed. The results are provided in FIG. 16 is for 12 individual thin films. As can be seen, exemplary sorptive phase coated SPME blades coupled with MS is an excellent technique that is used for isolation, sample clean-up and analysis with a great efficiency and reparability.

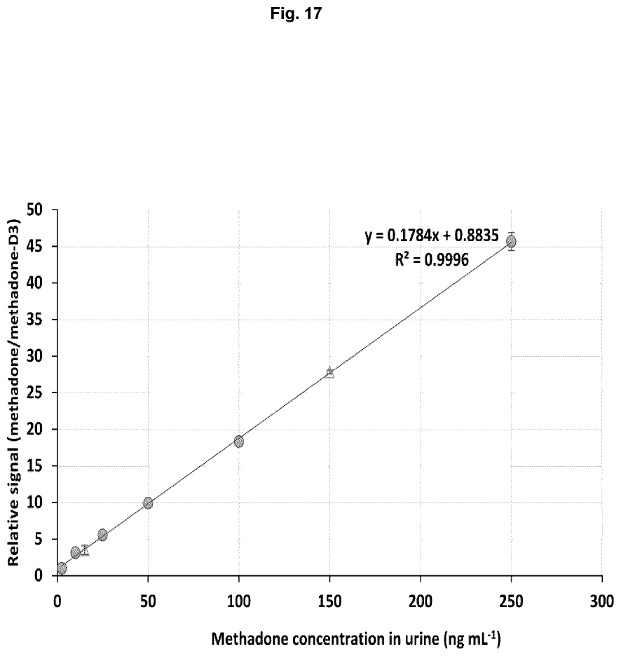

To evaluate the performance of sorptive phase coated SPME blades coupled with MS for determination of analytes of interest, the method was validated for analysis of methadone in urine. Thus, a pooled urine sample was spiked at various concentrations of methadone (2.5-250 ng mL⁻¹ for the calibration curve, and 15 and 150 ng mL⁻¹ for calibration check). All the samples were also spiked with methadone-d3 (5 ng mL⁻¹) as internal standard. The calibration curve was plotted (FIG. 17) which showed excellent linearity (R2=0.9996). The accuracy values were 97.0 for 15 ng mL⁻¹ and 101% for 150 ng mL⁻¹ with precision values of 9.6% and 1.2%, respectively.

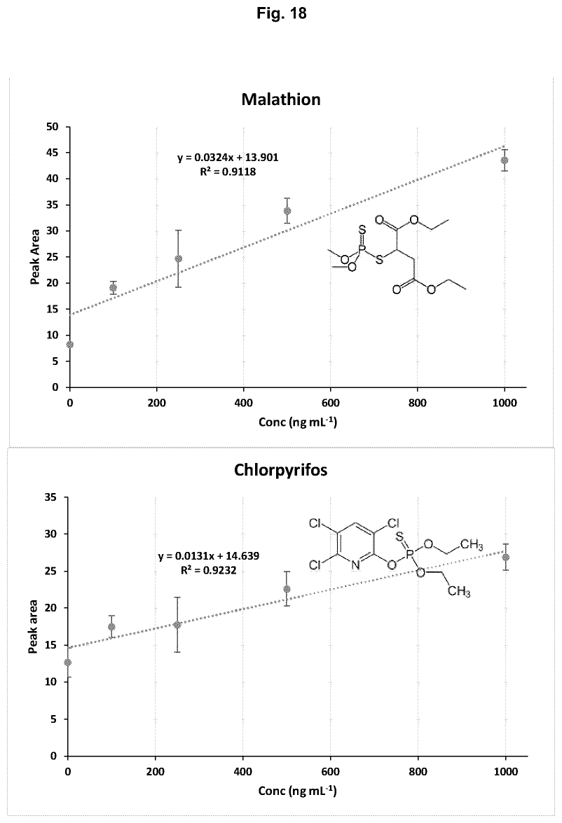

In addition to directly coupling the exemplary SPME metallic blades to the MS, the exemplary SPME fiberglass mesh devices prepared using Formula III have also been directly coupled for the analysis of OPPs to the MX handheld mass spectrometer by 908 Devices. In this work, OPPs are extracted from water samples using the exemplary SPME mesh devices. After drying, the exemplary SPME mesh device is subjected to heating at the inlet of the mass spectrometer at around 200° C. The analytes are thermally desorbed from the mesh and can be analyzed using the handheld MS (FIG. 18). This allows for the ability to conduct on-site sampling.

### i) Suitability of Porous Extraction Phase for Thermal Desorption:

One of the major problems associated with commercially available thin film microextration (TFME) sorbents for thermal desorption is large background noise due to bleeding siloxane groups of PDMS. One way to minimize this drawback is to use carbon mesh as a support for the device so that the volume of prepolymer solution used for fabricating films can be minimized. However, there is still a need to reduce the mass of sorbent used in these extraction devices further as significant bleeding still occurs. In the process of the application, a thin layer of polymer is formed during polymerization. The thickness can be well controlled, for example, by selecting an appropriate ratio and mixture of components. After formation of the polymeric network, a phase separation occurs after which a porous structure capable of adsorbing analytes is formed. After phase separation occurs further growth of polymeric network does not occur and therefore this process plays a role in the amount of polymer formed. And, therefore, the phase separation is a factor in determining the polymer thickness which should be thin enough to be use for extraction/desorption purposes. Further curing will not lead to expansion of the polymeric network. In comparison, fabrication using a polymeric binder like PDMS allows the polymer to grow in a membrane shape and form a thick layer of polymer. For example, HLB loaded PDMS membranes were prepared by bar coating with dimensions of 20 mm×4.75 mm×400 μm (L×W×T) [40].

While the present application has been described with reference to examples, it is to be understood that the scope of the claims should not be limited by the embodiments set forth in the examples, but should be given the broadest interpretation consistent with the description as a whole.

All publications, patents and patent applications are herein incorporated by reference in their entirety to the same extent as if each individual publication, patent or patent application was specifically and individually indicated to be incorporated by reference in its entirety. Where a term in the present application is found to be defined differently in a document incorporated herein by reference, the definition provided herein is to serve as the definition for the term.

### FULL CITATIONS FOR DOCUMENTS REFERRED TO IN THE SPECIFICATION

A number of publications are cited herein. Full citations for these references are provided below. Each of these references is incorporated herein by reference in its entirety into the present disclosure, to the same extent as if each individual reference was specifically and individually indicated to be incorporated by reference.

[1] E.V.S. Maciel, A.L. de Toffoli, E.S. Neto, C.E.D. Nazario, F.M. Lanças, New materials in sample preparation: Recent advances and future trends, TrAC Trends in Analytical Chemistry 119 (2019) 115633. https://doi.org/https://doi.org/10.1016/j.trac.2019.115633.

[2] C.I.C. Silvestre, J.L.M. Santos, J.L.F.C. Lima, E.A.G. Zagatto, Liquid-liquid extraction in flow analysis: A critical review, Analytica Chimica Acta 652(1) (2009) 54-65. https://doi.org/https://doi.org/10.1016/j.aca.2009.05.042.

[3] C. Calderilla, F. Maya, L.O. Leal, V. Cerdà, Recent advances in flow-based automated solid-phase extraction, TrAC Trends in Analytical Chemistry 108 (2018) 370-380. https://doi.org/https://doi.org/10.1016/j.trac.2018.09.011.

[4] M. Biziuk, A. Przyjazny, J. Czerwinski, M. Wiergowski, Occurrence and determination of pesticides in natural and treated waters, Journal of Chromatography A 754(1-2) (1996) 103-123.

[5] K. Gorynski, A critical review of solid-phase microextraction applied in drugs of abuse determinations and potential applications for targeted doping testing, TrAC Trends in Analytical Chemistry 112 (2019) 135-146. https://doi.org/https://doi.org/10.1016/j.trac.2018.12.029.

[6] F. Zhao, Y. Meng, J.L. Anderson, Polymeric ionic liquids as selective coatings for the extraction of esters using solid-phase microextraction, Journal of Chromatography A 1208(1) (2008) 1-9. https://doi.org/https://doi.org/10.1016/j.chroma.2008.08.071.

[7] P. Tölgyessy, S. Nagyová, M. Sládkovičová, Determination of short chain chlorinated paraffins in water by stir bar sorptive extraction-thermal desorption-gas chromatography-triple quadrupole tandem mass spectrometry, Journal of Chromatography A 1494 (2017) 77-80. https://doi.org/https://doi.org/10.1016/j.chroma.2017.03.012.

[8] G. Mafra, A.A. Vieira, J. Merib, J.L. Anderson, E. Carasek, Single drop microextraction in a 96-well plate format: A step toward automated and high-throughput analysis, Analytica Chimica Acta 1063 (2019) 159-166. https://doi.org/https://doi.org/10.1016/j.aca.2019.02.013.

[9] V. Salvatierra-stamp, R. Muñiz-Valencia, J.M. Jurado, S.G. Ceballos-Magaña, Hollow fiber liquid phase microextraction combined with liquid chromatography-tandem mass spectrometry for the analysis of emerging contaminants in water samples, Microchemical Journal 140 (2018) 87-95. https://doi.org/https://doi.org/10.1016/j.microc.2018.04.012.

[10] E. Ranjbari, A .-A. Golbabanezhad-Azizi, M.R. Hadjmohammadi, Preconcentration of trace amounts of methadone in human urine, plasma, saliva and sweat samples using dispersive liquid-liquid microextraction followed by high performance liquid chromatography, Talanta 94 (2012) 116-122. https://doi.org/https://doi.org/10.1016/j.talanta.2012.03.004.

[11] J. Chen, H. Chen, X. Jin, H. Chen, Determination of ultra-trace amount methyl-, phenyl- and inorganic mercury in environmental and biological samples by liquid chromatography with inductively coupled plasma mass spectrometry after cloud point extraction preconcentration, Talanta 77(4) (2009) 1381-1387. https://doi.org/https://doi.org/10.1016/j.talanta.2008.09.021.

[12] M. Pastor-Belda, L. Marín-Soler, N. Campillo, P. Viñas, M. Hernández-Córdoba, Magnetic carbon nanotube composite for the preconcentration of parabens from water and urine samples using dispersive solid phase extraction, Journal of Chromatography A 1564 (2018) 102-109. https://doi.org/https://doi.org/10.1016/j.chroma.2018.06.025.

[13] M. Llompart, M. Celeiro, C. García-Jares, T. Dagnac, Environmental applications of solid-phase microextraction, TrAC Trends in Analytical Chemistry 112 (2019) 1-12. https://doi.org/https://doi.org/10.1016/j.trac.2018.12.020.

[14] É.A. Souza-Silva, R. Jiang, A. Rodríguez-Lafuente, E. Gionfriddo, J. Pawliszyn, A critical review of the state of the art of solid-phase microextraction of complex matrices I. Environmental analysis, TrAC Trends in Analytical Chemistry 71 (2015) 224-235.

[15] D. Kim, J. Han, Y. Choi, On-line solid-phase microextraction of triclosan, bisphenol A, chlorophenols, and selected pharmaceuticals in environmental water samples by high-performance liquid chromatography-ultraviolet detection, Analytical and bioanalytical chemistry 405(1) (2013) 377-387.

[16] N. Reyes-Garcés, M. Diwan, E. Boyaci, G.A. Gómez-Ríos, B. Bojko, J.N. Nobrega, F.R. Bambico, C. Hamani, J. Pawliszyn, In Vivo Brain Sampling Using a Microextraction Probe Reveals Metabolic Changes in Rodents after Deep Brain Stimulation, Analytical Chemistry 91(15) (2019) 9875-9884. https://doi.org/10.1021/acs.analchem.9b01540.

[17] J. Alberdi-Cedeño, M.L. Ibargoitia, M.D. Guillén, Monitoring of minor compounds in corn oil oxidation by direct immersion-solid phase microextraction-gas chromatography/mass spectrometry. New oil oxidation markers, Food Chemistry 290 (2019) 286-294. https://doi.org/https://doi.org/10.1016/j.foodchem.2019.04.001.

[18] D.J.S. Patinha, A.J.D. Silvestre, I.M. Marrucho, Poly(ionic liquids) in solid phase microextraction: Recent advances and perspectives, Progress in Polymer Science 98 (2019) 101148. https://doi.org/https://doi.org/10.1016/j.progpolymsci.2019.101148.

[19] K.C. Hernandes, É.A. Souza-Silva, C.F. Assumpção, C.A. Zini, J.E. Welke, Matrix-compatible solid phase microextraction coating improves quantitative analysis of volatile profile throughout brewing stages, Food Research International 123 (2019) 75-87. https://doi.org/https://doi.org/10.1016/j.foodres.2019.04.048.

[20] N. Reyes-Garces, E. Gionfriddo, G.A. Gómez-Ríos, M.N. Alam, E. Boyaci, B. Bojko, V. Singh, J. Grandy, J. Pawliszyn, Advances in solid phase microextraction and perspective on future directions, Analytical chemistry 90(1) (2017) 302-360.

[21] R.V. Emmons, R. Tajali, E. Gionfriddo, Development, Optimization and Applications of Thin Film Solid Phase Microextraction (TF-SPME) Devices for Thermal Desorption: A Comprehensive Review, Separations 6(3) (2019) 39. https://doi.org/10.3390/separations6030039.

[22] G.A. Gómez-Ríos, M.F. Mirabelli, Solid Phase Microextraction-Mass Spectrometry: Metanoia, TrAC Trends in Analytical Chemistry (2019).

[23] H. Piri-Moghadam, E. Gionfriddo, J.J. Grandy, M.N. Alam, J. Pawliszyn, Development and validation of eco-friendly strategies based on thin film microextraction for water analysis, Journal of Chromatography A 1579 (2018) 20-30. https://doi.org/https://doi.org/10.1016/j.chroma.2018.10.026.

[24] F.S. Mirnaghi, Y. Chen, L.M. Sidisky, J. Pawliszyn, Optimization of the Coating Procedure for a High-Throughput 96-Blade Solid Phase Microextraction System Coupled with LC-MS/MS for Analysis of Complex Samples, Analytical Chemistry 83(15) (2011) 6018-6025. https://doi.org/10.1021/ac2010185.

[25] N. Reyes-Garcés, B. Bojko, J. Pawliszyn, High throughput quantification of prohibited substances in plasma using thin film solid phase microextraction, Journal of Chromatography A 1374 (2014) 40-49.

[26] E. Boyaci, K. Goryński, C.R. Viteri, J. Pawliszyn, A study of thin film solid phase microextraction methods for analysis of fluorinated benzoic acids in seawater, Journal of Chromatography A 1436 (2016) 51-58.

[27] F. Ahmadi, C. Sparham, J. Pawliszyn, A flow-through aqueous standard generation system for thin film microextraction investigations of UV filters and biocides partitioning to different environmental compartments, Environmental Pollution 230 (2017) 663-673. https://doi.org/https://doi.org/10.1016/j.envpol.2017.06.092.

[28] J.J. Grandy, E. Boyaci, J. Pawliszyn, Development of a carbon mesh supported thin film microextraction membrane as a means to lower the detection limits of benchtop and portable GC/MS instrumentation, Analytical chemistry 88(3) (2016) 1760-1767.

[29] A. Azizi, F. Shahhoseini, A. Modir-Rousta, C.S. Bottaro, High Throughput Direct Analysis of Water using Solvothermal Headspace Desorption with Porous Thin Films, Analytica Chimica Acta 1087 (2019) 51-61.

[30] F. Shahhoseini, A. Azizi, S.N. Egli, C.S. Bottaro, Single-use porous thin film extraction with gas chromatography atmospheric pressure chemical ionization tandem mass spectrometry for high-throughput analysis of 16 PAHs, Talanta 207 (2020) 120320. https://doi.org/https://doi.org/10.1016/j.talanta.2019.120320.

[31] Y .-L. Wang, Y .-L. Gao, P .-P. Wang, H. Shang, S .-Y. Pan, X .-J. Li, Sol-gel molecularly imprinted polymer for selective solid phase microextraction of organophosphorous pesticides, Talanta 115 (2013) 920-927.

[32] C.M. Graham, Y. Meng, T. Ho, J.L. Anderson, Sorbent coatings for solid-phase microextraction based on mixtures of polymeric ionic liquids, Journal of separation science 34(3) (2011) 340-346.

[33] C.L. Lin, S. Lirio, Y.T. Chen, C.H. Lin, H.Y. Huang, A Novel Hybrid Metal-Organic Framework-Polymeric Monolith for Solid-Phase Microextraction, Chemistry-A European Journal 20(12) (2014) 3317-3321.

[34] X. Hu, Y. Fan, Y. Zhang, G. Dai, Q. Cai, Y. Cao, C. Guo, Molecularly imprinted polymer coated solid-phase microextraction fiber prepared by surface reversible addition-fragmentation chain transfer polymerization for monitoring of Sudan dyes in chilli tomato sauce and chilli pepper samples, Analytica chimica acta 731 (2012) 40-48.

[35] A. Azizi, C.S. Bottaro, A critical review of molecularly imprinted polymers for the analysis of organic pollutants in environmental water samples, Journal of Chromatography A (2019) 460603.

[36] H. Piri-Moghadam, M.N. Alam, J. Pawliszyn, Review of geometries and coating materials in solid phase microextraction: opportunities, limitations, and future perspectives, Analytica chimica acta 984 (2017) 42-65.

[37] H.R. Geng, S.S. Miao, S.F. Jin, H. Yang, A newly developed molecularly imprinted polymer on the surface of TiO2 for selective extraction of triazine herbicides residues in maize, water, and soil, Analytical and Bioanalytical Chemistry 407(29) (2015) 8803-8812. https://doi.org/10.1007/s00216-015-9039-x.

[38] L. Chen, X. Huang, Preparation and application of a poly (ionic liquid)-based molecularly imprinted polymer for multiple monolithic fiber solid-phase microextraction of phenolic acids in fruit juice and beer samples, Analyst 142(21) (2017) 4039-4047. https://doi.org/10.1039/C7AN01186E.

[39] G.A. Gómez-Ríos, M. Tascon, N. Reyes-Garcés, E. Boyaci, J. Poole, J. Pawliszyn, Quantitative analysis of biofluid spots by coated blade spray mass spectrometry, a new approach to rapid screening, Scientific reports 7(1) (2017) 1-7.

[40] J.J. Grandy, V. Singh, M. Lashgari, M. Gauthier, J. Pawliszyn, Development of a hydrophilic lipophilic balanced thin film solid phase microextraction device for balanced determination of volatile organic compounds, Analytical chemistry 90(23) (2018) 14072-14080.

1. A process of preparing a plurality of porous sorptive solid phase microextraction (SPME) devices comprising:
depositing a prepolymer composition on a surface of a solid support sheet to form a uniform prepolymer composition layer on the solid support sheet;
curing the prepolymer composition layer to form a porous sorptive polymer coated sheet; and
cutting the porous sorptive polymer coated sheet to form the plurality of porous sorptive SPME devices.

2. The process of claim 1, wherein the depositing is to an entire surface of the solid support sheet.

3. (canceled)

4. The process of claim 2, wherein the support sheet is a metal alloy support sheet and the metal alloy is stainless steel support sheet or the support sheet is a fiber-reinforced plastic support sheet and the fiber-reinforced plastic support sheet is a fiberglass mesh support sheet.

5. (canceled)

6. The process of claim 1, wherein the prepolymer composition comprises a monomer or a mixture of monomers, one or more cross-linking agents, one or more polymer initiators and one or more -porogens.

7. The process of claim 6, wherein the monomer or a mixture of monomers are selected from acrylic acid (AA), methacrylic acid (MAA), 2-(trifluoromethyl) acrylic acid (TFMAA), itaconic acid, p-vinylbenzoic acid, 2-acrylamido-2-methyl-1-propanesulfonic acid (AMPSA), 4-vinylbenzeneboronic acid, 2-vinylpyridine (2-VP), 4-vinylpyridine (4-VP), N,N-(diethylaminoethy methacrylate) (DEAEM), 1-vinylimidazolo allylamine, 1-vinylimidazole, 4-(5)-vinylimidazole, N-(2-aminethyl)-methacrylamide, N,N′-diethyl-4-styrylamidine, N,N,N-trimethylaminoethylmethacrylate, N-vinylpyrrolidone (NVP), urocanic ethyl ester, methyl methacrylate (MMA), 2-hydroxyethyl methacrylate (2-HEMA), 4-ethylstyrene, acrylamide, methacrylamide, trans-3-(3-pyridyl)-acrylic acid, acrylonitrile and styrene,
wherein the one or more cross linking agent are selected from ethylene glycol dimethacrylate (EGDMA) N, O-bismethacryloyl ethanolamine, N, N′-methylenebisacrylamide (MDAA), p-divinylbenzene (DVB), N,N′-1,3-phenylenebis(2-methyl-2-propenamide) (PDBMP), 3,5-bisacryloylamido benzoic acid, N, O-bisacryloyl-L-phenylalaninol, 1,3-diisopropenyl benzene (DIP), pentaerythritol triacrylate (PETRA), pentaerythritol pentacrylate (PRTEA), triethylolpropane trimethacrylate (TRIM), tetramethylene dimethacrylate (TDMA), 2,6-bisacryloylamidopyridine, 1,4-phenylene diacrylamide, 1,4-diacryloyl piperazine (DAP), N,N′-ethylenebismethacrylamide, N, N′-tetramethylenebismethacrylamide, N,N′-hexamethylenebismethacrylamide, anhydroerythritoldimethacrylate and 1,4,3,6-dianhydro-D-sorbitol-2,5-dimethacrylate and mixtures thereof.
wherein the one or more porogens are selected from toluene, xylene, methoxyethanol, chlorinated solvents, ethyl acetate, benzyl alcohol, 1-octanol, cyclohexane, isopropanol and acetonitrile, and mixtures thereof, and
wherein the one or more polymer initiators is selected from benzoyl peroxide, acetyl peroxide, lauryl peroxide, azobisisobutyronitrile (AIBN), t-butyl peracetate, cumyl peroxide, t-butyl peroxide; t-butyl hydroperoxide, bis(isopropyl)peroxy-dicarbonate, benzoin methyl ether, 2.2′-azobis(2,4-dimethylvaleronitrile), tertiary butyl peroctoate, phthalic peroxide, diethoxyacetophenone and tertiarybutyl peroxypivalate, diethoxyacetophenone, 1-hydroxycyclohexyl phenyl ketone, 2,2-dimethyoxy-2-phenylacetophenone (DMPA) and phenothiazine, diisopropylxanthogen disulfide, 2,2′-azobis-(2-amidinopropane); 2,2′-azobisisobutyronitrile, 4,4′-azobis-(4-cyanovaleric acid), 1,1′-azobis-(cyclohexanecarbonitrile), 2,2′-azobis-(2,4-dimethylvaleronitrile) (ABDV), and mixtures thereof.

8. (canceled)

9. The process of claim 7, wherein the monomer or a mixture of monomers are selected from 4-vinyl pyridine (4-VP) and methacrylic acid (MAA); the one or more cross linking agents is ethylene glycol dimethacrylate (EGDMA); or the porogen is 1-octanol; or the polymer initiator is 2.2-dimethoxy-2-phenylacetophenone (DMPA).

10.-17. (canceled)

18. The process of claim 6, wherein prepolymer composition further comprises one or more template molecules.

19. The process of claim 18, wherein the template molecule is selected from 2-{[diethoxy(sulfanylidene)-λ-phosphanyl]amino}acetic acid, O,O′-diethyl chlorothiophosphate, diphenyl chlorophosphate, 2-[(diphenoxyphosphoryl)amino]acetic acid, 4-{[diethoxy(sulfanylidene)-λ-phosphanyl]amino}butanoic acid, 4-[(diphenoxyphosphoryl) amino]butanoic acid, carbamazepine, and benzyl (3-(10,11-dihydro-5H-dibenzo[b,f]azepin-5-yl)propyl) (methyl)carbamate (CBZ-desipramine), or the template molecule is a target molecule and the target molecule is a drug of abuse, a tricyclic antidepressant, an organophosphorus pesticides (OPP), a polycyclic aromatic hydrocarbon (PAH), or mixtures thereof.

20. (canceled)

21. (canceled)

22. The process of claim 6, wherein the prepolymer composition further comprises an additive, wherein the additive is a plasticizer, a pigment, a thermal stabilizer, an anti-static agent, a heat and/or light stabilizer, a filler or a fiber reinforcement.

23. (canceled)

24. (canceled)

25. The process of claim 6, wherein the monomer or mixture of monomers is selected from methacrylic acid (MAA), 2-vinylpyridine (2-VP), or 4-vinylpyridine (4-VP) and the one or more cross linking agents are selected from ethylene glycol dimethacrylate (EGDMA), triethylolpropane trimethacrylate (TRIM), tetramethylene dimethacrylate (TDMA), anhydroerythritoldimethacrylate and 1,4,3,6-dianhydro-D-sorbitol-2,5-dimethacrylate and mixtures thereof.

26. The process of claim 6, wherein the monomer is 4-VP or MAA, the crosslinking agent is EGDMA and the polymer initiator is DMPA.

27. (canceled)

28. The process of claim 6, wherein the molar ratio of monomer or mixture of monomers to crosslinking agent is about 1:15 to about 1:1.

29. (canceled)

30. The process of claim 1, wherein the depositing is by dipping, spreading, brush painting, drop-casting or spraying, and wherein the curing is UV curing

31.-34. (canceled)

35. The process of claim 1, wherein the porous sorptive polymer coated sheet comprises a uniform porous sorptive polymer coating layer on the solid support sheet, and
the uniform porous sorptive polymer coating layer has a thickness of about 2 μm to about 100 μm, or
the uniform porous sorptive polymer coating layer comprises particles having a particle size of from about from about 1 nm to about 1000 nm, about 10 nm to about 900 nm, about 50 nm to about 800 nm, about 50 nm to about 700 nm or about 100 nm to about 650 nm.

36.-50. (canceled)

51. The process of claim 1, wherein the porous sorptive SPME devices are configured for use directly with an analytical instrument.

52. (canceled)

53. (canceled)

54. A plurality of porous sorptive solid phase microextraction (SPME) devices obtained by the process of any one of claim 1.

55. (canceled)

56. A porous sorptive solid phase (SPME) microextration device comprising:
a porous sorptive polymer coating layer covering at least a portion of a solid support,
wherein the porous sorptive SPME device is one of a plurality of porous sorptive SPME devices formed by cutting a porous sorptive polymer coated sheet.

57. The SPME device of claim 56, wherein the porous sorptive polymer coated sheet is prepared by a process comprising:
depositing a prepolymer composition on a surface of a solid support sheet to form a uniform prepolymer composition layer on the solid support sheet;
curing the prepolymer composition layer to form the porous sorptive polymer coated sheet; and
optionally, removing non-adhered material from the porous sorptive polymer coated sheet, and
wherein the porous sorptive SPME device comprises a uniform porous sorptive polymer coating layer covering at least a portion of a solid support.

58. (canceled)

59. A method of extracting one or more analytes from a sample matrix comprising,
providing a porous sorptive solid phase microextraction (SPME) device of claim 55 comprising a sorptive polymer coating layer covering at least a portion of a solid support;
exposing the porous sorptive polymer coating layer to the sample matrix comprising the one or more analytes under conditions for the porous sorptive polymer coating layer to extract the one or more analytes from the sample matrix, and
separating the porous sorptive SPME device from the sample matrix,
wherein the exposing the porous sorptive polymer coating layer to the sample matrix comprises contacting the porous sorptive polymer coating layer with the sample matrix, or placing the porous sorptive polymer coating layer in a headspace suitably close to the sample matrix, and
wherein the contacting of the porous sorptive polymer coating layer with the sample matrix comprises applying the sample matrix to the porous sorptive polymer coating layer.

60.-72. (canceled)

73. The method of claim 59, wherein the method further comprises desorbing the one or more analytes from the porous sorptive polymer coating layer, and detecting the one or more analytes.

74.-83. (canceled)
